(19) United States
(12) Patent Application Publication
(10) Pub. No.: US 2025/0392917 A1
(43) Pub. Date: Dec. 25, 2025

(54) ELECTRONIC APPARATUS AND INFORMATION PROCESSING DEVICE

(71) Applicant: PFU LIMITED, Ishikawa (JP)

(72) Inventor: Tomoaki WADA, Ishikawa (JP)

(21) Appl. No.: 19/243,980

(22) Filed: Jun. 20, 2025

(30) Foreign Application Priority Data
Jun. 21, 2024 (JP) 2024-100600

(51) Int. Cl. H04W 12/50

(52) U.S. Cl. CPC H04W 12/50

(57) ABSTRACT

An electronic apparatus including circuitry to perform pairing with an information processing device in response to receiving a pairing request for wireless communication in accordance with a wireless communication standard from the information processing device to complete the pairing, and check whether a first predetermined operation is performed related to the electronic apparatus after completion of the pairing or whether information input by a second predetermined operation performed after the completion of the pairing meets a predetermined condition.

### CROSS-REFERENCE TO RELATED APPLICATIONS

This patent application is based on and claims priority pursuant to 35 U.S.C. § 119 (a) to Japanese Patent Application No. 2024-100600, filed on Jun. 21, 2024, in the Japan Patent Office, the entire disclosure of which is hereby incorporated by reference herein.

### BACKGROUND

The present disclosure relates to an electronic apparatus and an information processing device.

A method of pairing a trusted device and a second device has been proposed. Such a method includes receiving a request to pair the second device with a first device, mutually authenticating the first device and the second device and obtaining from the first device a device identification relating to the first device, putting the first device into a trusted mode in which it will not engage in a pairing procedure with any device other than the second device, obtaining a device identification from the trusted device, comparing the device identification from the trusted device with the device identification obtained in the authenticating step, if the device identification relating to the first device matches the device identification obtained from the trusted device, determining that the first device is the trusted device and sending a pairing acceptance to the trusted device, and pairing the trusted device and the second device in response to the receipt of a second pairing acceptance from a user entered into the trusted device.

In the related art, a pairing process is performed when wireless communication is established according to wireless communication standards such as BLUETOOTH (registered trademark).

### SUMMARY

The electronic apparatus according to one aspect of the present disclosure includes circuitry to perform pairing with an information processing device in response to receiving a pairing request for wireless communication in accordance with a wireless communication standard from the information processing device to complete the pairing, and check whether a first predetermined operation is performed related to the electronic apparatus after completion of the pairing or whether information input by a second predetermined operation performed after the completion of the pairing meets a predetermined condition.

The electronic apparatus according to another aspect of the present disclosure includes circuitry to receive a pairing request, establish a pairing based on the pairing request, and determine to cancel the pairing when failing to confirm that a first predetermined operation is performed related to the electronic apparatus or when failing to confirm that information input by a second predetermined operation meets a predetermined condition, within a predetermined time after the pairing is established.

The information processing device according to still another aspect of the present disclosure includes circuitry to transmit a pairing request to an electronic apparatus, and check whether a first predetermined operation is performed related to the electronic apparatus after pairing for wireless communication in accordance with a wireless communication standard is completed based on the pairing request or whether information input by a second predetermined operation performed after completion of the pairing meets a predetermined condition.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a system according to an embodiment;

FIG. 2 is a schematic diagram illustrating a functional configuration of an electronic apparatus (scanner) according to an embodiment;

FIG. 3 is a diagram for explaining confirmation operation details according to an embodiment;

FIG. 4 is a diagram illustrating an example of display of information on a confirmation operation according to an embodiment;

FIG. 5 is a schematic diagram illustrating a functional configuration of an information processing device (user terminal) according to an embodiment;

FIG. 6 is a diagram illustrating an example of a screen displaying a list of connectable scanners according to an embodiment;

FIG. 7 is a diagram illustrating a first example of a confirmation operation instruction screen according to an embodiment;

FIG. 8 is a diagram illustrating a second example of a confirmation operation instruction screen according to an embodiment;

FIG. 9 is a flowchart and a communication sequence diagram illustrating an overview of a pairing process according to an embodiment;

FIG. 10 is a flowchart and a communication sequence diagram illustrating an overview of a check process when a scanner detects that a confirmation operation has been performed, according to an embodiment;

FIG. 11 is a flowchart and a communication sequence diagram illustrating an overview of another check process when a scanner detects that a confirmation operation has been performed, according to an embodiment;

FIG. 12 is a flowchart and a communication sequence diagram illustrating an overview of a check process when a user terminal detects that a confirmation operation has been performed, according to an embodiment;

FIG. 13 is a flowchart and a communication sequence diagram illustrating an overview of another check process when a user terminal detects that a confirmation operation has been performed, according to an embodiment;

FIG. 14 is a flowchart and a communication sequence diagram illustrating an overview of a check process according to an embodiment;

FIG. 15 is a flowchart and a communication sequence diagram illustrating an overview of another check process according to an embodiment;

FIG. 16 is a flowchart and a communication sequence diagram illustrating an overview of still another check process according to an embodiment;

FIG. 17 is a flowchart and a communication sequence diagram illustrating an overview of still another check process according to an embodiment; and

FIG. 18 is a flowchart and a communication sequence diagram illustrating an overview of still another check process according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An electronic apparatus, an information processing device, a system, a method, and a program according to embodiments of the present disclosure are described below with reference to the drawings. Embodiments described below are illustrative, and do not limit the electronic apparatus, the information processing device, the system, the method, and the program according to the present disclosure to the specific configurations described below. In the implementation, specific configurations may be adopted appropriately according to the mode of implementation, and various improvements and modifications may be made.

In the present embodiment described below, the electronic apparatus, the information processing device, the system, the method, and the program according to some aspects of the present disclosure are applied to a system that establishes wireless communication according to BLUETOOTH. However, the electronic apparatus, the information processing device, the system, the method, and the program according to embodiments of the present disclosure can be widely applicable to establishing wireless communication in accordance with any wireless communication standard, and what the present disclosure is applied is not limited to those described below.

In the related art, pairing is performed when wireless communication is established in accordance with a wireless communication standard such as BLUETOOTH between an information processing device (e.g., a smartphone or a personal computer (PC)) and an electronic apparatus (e.g., a peripheral apparatus such as a scanner). However, simplifying a user operation in the authentication (authentication procedure) during such pairing increases the risk of communicating with an unintended apparatus or device (e.g., security risks related to wireless communication such as spoofing, a man-in-the-middle attack, and indiscriminate connection, and a risk of incorrect selection (mix-up) of an electronic apparatus). On the other hand, trying to avoid the risk of communicating with an unintended apparatus or device results in more complex user operations for pairing, leading to increased user effort. In other words, the issue is that it is difficult to balance reducing user effort, ensuring security, and preventing communication with an incorrectly selected apparatus or device.

For example, in BLUETOOTH pairing, multiple pairing methods (authentication methods, Association Models) are available, and four types of authentication methods, Just Works, Passkey Entry, Numeric Comparison, and Out-of-Band (OOB), are available. Just Works is an authentication method that does not involve a user operation such as an input operation of inputting a passkey (Personal Identification Number (PIN) code). In Just Works, a connection partner is typically authenticated automatically without a user operation. However, there are scanners (models) that require an operation to confirm whether to perform pairing (e.g., an operation of inputting Yes/No in response to the question, “Do you want to perform pairing?”). Therefore, Just Works is an authentication method that does not involve an operation other than an input operation for confirming permission to perform pairing. Further, Just Works is an authentication method that does not involve an operation (user operation) for confirming that a connection destination is correct, and may be referred to as an authentication method without authentication (pairing method without authentication) in the BLUETOOTH standard. Passkey Entry is an authentication method in which a 6-digit PIN code (number) is displayed on one of the devices to allow the user to confirm the PIN code and input the PIN code to the other of the devices. Numeric Comparison is an authentication method in which both devices display a 6-digit PIN code (number), and the user is caused to confirm whether the PIN codes of both devices are the same and input the check result. Out-of-Band is an authentication method that passes authentication information by a method other than BLUETOOTH, such as Near Field Communication (NFC) or Universal Serial Bus (USB). Therefore, the out-of-band authentication method requires another communication method or medium.

For the purpose of simplifying user operations (facilitating user convenience) and because scanners do not necessarily have a screen display with sufficient display capabilities, it is preferable to use Just Works. However, in Just Works, for example, pairing is completed without confirming whether the individual scanner selected by the user on the smartphone is an individual scanner that the user actually wants to pair with. That is, the connection destination is not confirmed to be correct. Therefore, the user may not notice if the user incorrectly selected the wrong scanner or have fallen victim to impersonation. Although the user can verify that the scanner is correctly selected, in advance, by carefully checking the serial number or other information on the scanner. However, in practice, checking the back or the bottom of each scanner causes user effort and is not realistic.

Accordingly, in the system described in the present embodiment, pairing of the information processing device and the electronic apparatus is performed using an authentication method (e.g., Just Works) that does not involve an operation for confirming that the connection destination is correct, and whether a first predetermined operation instructed to be performed by the user is performed related to the electronic apparatus is checked after the pairing is completed, or whether information input by a second predetermined operation performed after the pairing is completed meets a predetermined condition is checked. That is, after pairing is completed by an authentication method that does not involve an operation for confirming that a connection destination is correct, the connection destination is confirmed to be correct. Thus, pairing is performed by an authentication method that does not involve an operation for confirming that a connection destination is correct, thereby reducing the user effort related to wireless connection (pairing), and confirming that the connection destination is correct after completion of pairing can reduce the risk of communicating with an unintended apparatus or device (ensuring security, preventing communication with an electronic apparatus is incorrectly selected, etc.). However, in the present embodiment, the authentication method used for pairing (authentication) performed between the information processing device and the electronic apparatus is desirably an authentication method that does not involve an operation for confirming that a connection destination is correct, but another authentication method (e.g., Passkey Entry, Numeric Comparison, or Out-of-Band, which is an authentication method involving an operation for confirming that a connection destination is correct) may be used.

### System Configuration

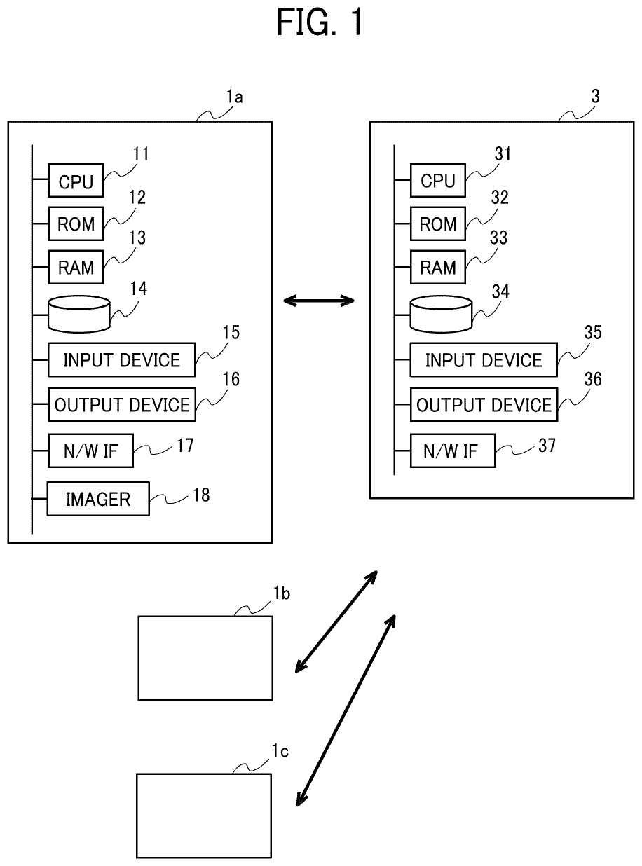

FIG. 1 is a schematic diagram illustrating a configuration of a system according to the present embodiment. The system according to the present embodiment includes one or more electronic apparatuses 1 and an information processing device 3. In the present embodiment, the system includes three electronic apparatuses 1 (an electronic apparatus 1a, an electronic apparatus 1b, and an electronic apparatus 1c). However, the system may include any number of electronic apparatuses 1. The information processing device 3 and at least one electronic apparatus 1 establish wireless communication (wireless connection) in accordance with a predetermined wireless communication standard in response to a user operation performed on the information processing device 3. Each electronic apparatus 1 can be connected to (paired with) a plurality of information processing devices 3.

The electronic apparatus 1 (the electronic apparatus 1a, the electronic apparatus 1b, or the electronic apparatus 1c) can establish a wireless connection (wireless communication) with the information processing device 3. In the present embodiment, a scanner is used as an example of the electronic apparatus 1. In the following description, the electronic apparatus 1 (the electronic apparatus 1a, the electronic apparatus 1b, or the electronic apparatus 1c) is referred to as a scanner 1 (a scanner 1a, a scanner 1b, or a scanner 1c). The scanner 1 is an apparatus (peripheral device) that acquires image data by imaging documents, business cards, receipts, photographs/illustrations, etc., set by the user. The scanner 1 is a computer including a central processing unit (CPU) 11, a read-only memory (ROM) 12, a random-access memory (RAM) 13, a storage device 14 such as an electrically erasable programmable read-only memory (EEPROM) and a hard disk drive (HDD), an input device 15 such as a keyboard, a mouse, or a touch panel, an output device 16 such as a display, a communication unit 17 such as a network interface card (NIC), and an imager 18 to image a medium such as a document. Regarding the specific hardware configuration of the scanner 1, any component may be omitted, replaced, or added as appropriate according to a mode of implementation. Further, the scanner 1 is not limited to an apparatus having a single housing. The scanner 1 may be implemented by a plurality of apparatuses using, for example, a so-called cloud or distributed computing technology.

The scanner 1 may be a scanner that includes either the input device 15 or the output device 16. Alternatively, the scanner 1 may be a scanner that does not include either the input device 15 or the output device 16. The scanner 1a, the scanner 1b, and the scanner 1c may be scanners of the same model or scanners of different models from each other. In the present embodiment, the scanner 1 is used as an example of the electronic apparatus 1. However, the electronic apparatus 1 wirelessly connected to the information processing device 3 is not limited to a scanner. The electronic apparatus 1 may be another peripheral device (an output device such as a printer or a display, an input device such as a mouse or a keyboard, an auxiliary storage device, etc.). Further, the electronic apparatus 1 used in the present embodiment is merely an example, and any other apparatus (device) that can wirelessly connect to the information processing device 3 may also be used. The electronic apparatus 1a, the electronic apparatus 1b, and the electronic apparatus 1c may be the same type of electronic apparatus (e.g., all the electronic apparatuses are scanners), or may be different types of electronic apparatus (e.g., the electronic apparatus 1a is a scanner, and the electronic apparatus 1b is a printer).

The information processing device 3 is a computer including a CPU 31, a ROM 32, a RAM 33, a storage device 34, an input device 35 such as a keyboard, a mouse, or a touch panel, an output device 36 such as a display, and a communication unit 37 such as an NIC. Examples of the information processing device 3 include a personal computer (PC), a smartphone, and a tablet. Regarding the specific hardware configuration of the information processing device 3, any component may be omitted, replaced, or added as appropriate according to a mode of implementation. Further, the information processing device 3 is not limited to an apparatus having a single housing. The information processing device 3 may be implemented by multiple apparatuses using, for example, a so-called cloud or distributed computing technology. In the present embodiment, the information processing device 3 is a terminal apparatus used by a user. In the following description, the information processing device 3 is referred to as a “user terminal 3.”

As described above, wireless communication (wireless connection) is established between the electronic apparatus (scanner) 1 and the information processing device (user terminal) 3 according to a predetermined wireless communication standard (referred to as a “first wireless communication standard” in the following description). In the present embodiment, BLUETOOTH, which is a short-range wireless communication standard, is used as an example of the “first wireless communication standard.” The “first wireless communication standard” may be, for example, BLUETOOTH Classic or BLUETOOTH Low Energy (BLE). In BLUETOOTH, a procedure (process) called “pairing” is performed to implement secure communication. In such “pairing,” the master device and the slave device each register the other and exchange keys (encryption keys) for data encryption. A procedure (process) for storing (saving) the encryption key exchanged by the pairing is called “bonding.” By bonding, when the device is reconnected to the same partner, the device can be connected to the partner without performing the pairing again, by using the stored encryption key. However, the electronic apparatus 1 and the information processing device 3 according to the present embodiment may or may not have a bonding function. In the present embodiment, BLUETOOTH is exemplified as the first wireless communication standard. However, the first wireless communication standard may be another wireless communication standard that involves pairing, such as ZIGBEE (registered trademark).

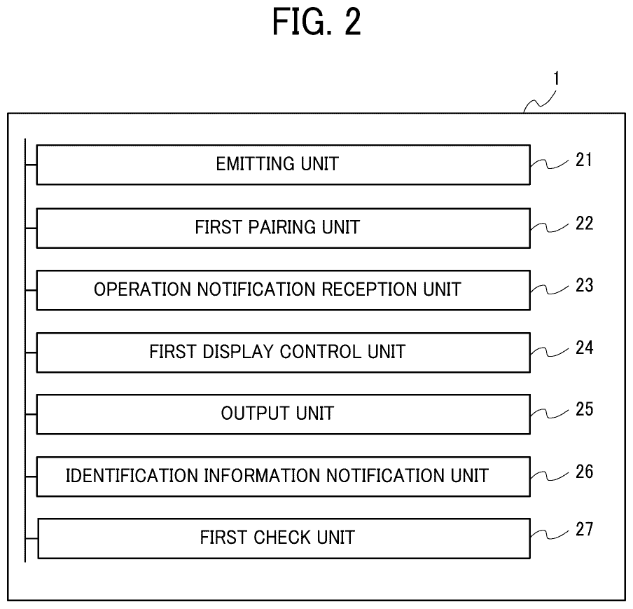

FIG. 2 is a schematic diagram illustrating a functional configuration of the electronic apparatus (scanner) 1 according to the present embodiment. The CPU 11 executes a program loaded onto the RAM 13 from the storage device 14, to control the hardware components of the electronic apparatus 1. Thus, the electronic apparatus 1 functions as an apparatus including an emitting unit 21, a first pairing unit 22 (corresponding to a “pairing unit” of the electronic apparatus 1 of the present application), an operation notification reception unit 23, a first display control unit 24 (corresponding to a “display control unit” of the electronic apparatus 1 of the present application), an output unit 25, an identification information notification unit 26, and a first check unit 27 (corresponding to a “check unit” of the electronic apparatus 1 of the present application). In the present embodiment and other embodiments described below, the functions of the electronic apparatus 1 are executed by the CPU 11, which is a general-purpose processor. Alternatively, a part or all of these functions may be executed by one or multiple dedicated processors.

The emitting unit 21 emits a radio wave for connection (advertising (signal)). Advertising is a wireless signal that notifies nearby devices of the presence and information of the own apparatus (scanner 1).

Advertising can include a service Universally Unique Identifier (UUID) that can identify (indicate) the functions (services) that the own apparatus has. In the present embodiment, Just Works that is an authentication method that does not involve an operation for confirming that a connection destination is correct is used as an example of a service employed by the scanner 1. That is, in the present embodiment, the advertising emitted by the scanner 1 includes the service UUID for identifying Just Works. In the present embodiment, the scanner 1 at least holds the service UUID for identifying Just Works in advance and emits advertising including the service UUID. The service UUID is a 128-bit value and represented as a character string that includes a hexadecimal string and a hyphen. The service UUID for identifying Just Works in the present embodiment is also a 128-bit value, but for the sake of simplicity, the UUID is referred to as “UUID A” in the following description. The advertising may include any other information such as the address and the apparatus name of the own apparatus (scanner 1) in addition to the service UUID. The emitting unit 21 periodically emits advertising (at a predetermined interval such as every second), but the emission cycle may be any cycle.

The first pairing unit 22 receives a pairing request for wireless communication in accordance with a first wireless communication standard (BLUETOOTH) from the user terminal 3. Upon receiving a pairing request specifying the UUID A, the first pairing unit 22 performs pairing with Just Works between the own apparatus (scanner 1) and the user terminal 3 that is the source of the pairing request, and completes (establishes) the pairing. At this time, the first pairing unit 22 transmits a pairing response to the user terminal 3, which is the source of the pairing request. As a result, a connection for wireless communication (first wireless communication) in accordance with the first wireless communication standard is established between the scanner 1 and the user terminal 3. The first pairing unit 22 cancels pairing as appropriate. For example, when the success of a confirmation operation is not confirmed within a predetermined period (e.g., within a predetermined time (waiting time) from the time when the pairing is completed or the time when the user is instructed to perform the confirmation operation), the first pairing unit 22 cancels the completed pairing. The success of a confirmation operation includes the event in which the confirmation operation is successfully performed and the event in which information input by the confirmation operation meets a predetermined condition. Thus, when the scanner intended by the user is not paired (the assumption of the user is incorrect), the pairing can be automatically canceled without any manual operation from the user to cancel the pairing. When the success of the confirmation operation is confirmed within the predetermined period, the completed pairing is maintained.

The “predetermined period” and the “predetermined time” may be pre-stored in the scanner 1 or may be received from the user terminal 3. The “predetermined period” and the “predetermined time” may be fixed or may be set to be dynamically changeable by at least the own apparatus (scanner 1) or the user terminal 3 according to at least one of the details of the confirmation operation, a user characteristic, the details of settings of the own apparatus, and the details of settings of the user terminal 3. For example, the predetermined time (waiting time) is dynamically changed according to a user characteristic indicating that the user is extremely slow in operation in the initial settings wizard of the scan application. In this case, the user is assumed to be unfamiliar with the apparatus, and the predetermined time (waiting time) may be extended for a longer period (e.g., doubled) accordingly. Thus, the predetermined period (predetermined time) that is the time limit for the confirmation operation can be optimally set according to the details of the confirmation operation, the user characteristic, etc. In this way, the first pairing unit 22 performs various processing related to pairing (which may include, in addition to the above-described processing, exchanging encrypted information (encryption key)).

The operation notification reception unit 23 receives information on a confirmation operation (corresponding to a “predetermined operation” in the present embodiment) from the user terminal 3. In the description of the present embodiment, the “confirmation operation” is an operation instructed to the user to perform to check whether the connection destination is correct (whether the electronic apparatus has been connected to the apparatus intended by the user), and is an operation performed by the user related to the right electronic apparatus that is intended as a connection target (pairing target) by the user. In the present embodiment, after the pairing is completed, the user is instructed to perform the confirmation operation. The confirmation operation is an operation performed related to the own apparatus (scanner 1) or the user terminal 3. The “right electronic apparatus intended by the user as a connection target” is an electronic apparatus that is desired by the user to be connected to the user terminal 3, for example, an electronic apparatus whose installed position is known by the user (such as an electronic apparatus where the user can visually recognize its position by standing in front of the electronic apparatus). As described later, when the user selects the scanner 1 to be connected to the user terminal 3 on a scanner selection screen 50, the user may incorrectly select a wrong scanner (select a scanner that is not the intended scanner) on the scanner selection screen 50. In such a case, the scanner 1 selected by the user on the scanner selection screen 50 does not correspond to the “right electronic apparatus (scanner) intended by the user as a connection target” in the present embodiment. In the present embodiment, by causing the user to perform the confirmation operation after the pairing is completed, whether the scanner 1 paired with the user terminal 3 is the “right scanner intended as a connection target by the user” can be checked. In the following description, the “right scanner intended by the user as a connection target (pairing target)” is referred to simply as a “right scanner.” In the present embodiment, eight confirmation operations (confirmation operations 1 to 8) are used as examples of the confirmation operations (details of the confirmation operations).

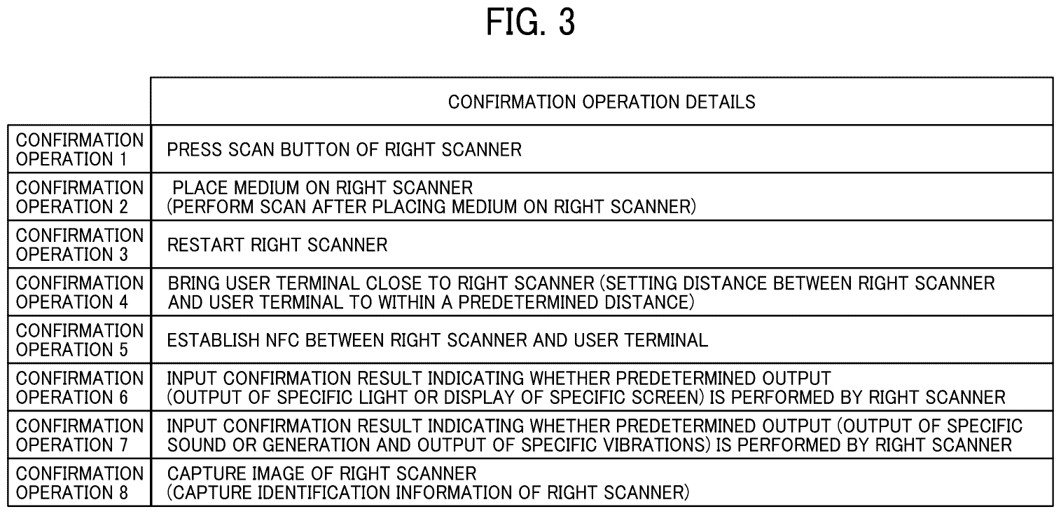

FIG. 3 is a diagram for explaining confirmation operation details according to the present embodiment. As illustrated in FIG. 3, confirmation operations 1 to 8 are examples of the confirmation operations to be instructed to the user in the present embodiment. The confirmation operation 1 is an operation of pressing a button (e.g., a scan button) on the right scanner. The button to be pressed may be a button displayed on a display of the scanner 1 or a button that is a component of the scanner 1. The confirmation operation 2 is an operation of placing (setting) a medium such as a document on the right scanner (media tray) or an operation for performing scan (activating a specific function) after placing a medium such as a document on the right scanner. The confirmation operation may be an operation for activating another specific function of the scanner 1 instead of activating the scan function. The confirmation operation 3 is an operation for restarting the right scanner. For example, the user may perform an operation of opening and closing the media tray cover to restart the scanner 1, when the scanner 1 is a scanner that is designed to be turned on and off by opening and closing the media tray cover, respectively. The confirmation operation 4 is an operation of bringing the user terminal 3 close to the right scanner (setting the distance between the right scanner and the user terminal 3 to within a predetermined distance). The confirmation operation 5 is an operation for establishing wireless communication (e.g., near field communication (NFC)) in accordance with a wireless communication standard other than the first wireless communication standard between the right scanner and the user terminal 3. As described above, the confirmation operations 1 to 5 are examples of operations (corresponding to “first predetermined operations” of the present application) performed related to (on or for) the right scanner.

The confirmation operation 6 is an operation for inputting a result obtained by checking by the user whether a predetermined output (output of a specific light or display of a specific screen) is being performed by the right scanner. The confirmation operation 7 is an operation for inputting a result obtained by checking by the user whether a predetermined output (output of a specific sound or generation of a specific vibration) is being performed by the right scanner. The “predetermined output” is an output indicating that the scanner has been paired with the user terminal 3. The predetermined output is described in detail later. The confirmation operation 8 is an operation for capturing an image of the right scanner (identification information of the right scanner). The confirmation operations 6 and 7 are examples of operations of confirming, by the user, whether a post-pairing change occurs in the right scanner (inputting the user confirmation result, etc.) The confirmation operations 6 to 8 are examples of the “second predetermined operation” in the present application.

In the present embodiment, the confirmation operation instructed to the user to perform is at least one of the eight confirmation operations described above. However, the confirmation operation may be any operation other than the eight confirmation operations described above as long as the operation can check whether the paired scanner is the right scanner. The confirmation operations 1 to 8 are operations that can be performed when the user is near the scanner 1.

Information on the confirmation operation received by the operation notification reception unit 23 includes details of the content of the confirmation operation and a time for waiting for the confirmation operation (waiting time). In the cases of the confirmation operations 6 to 8, the information on the confirmation operation may include the details (instruction) of output processing or identification information-transmission processing to be performed by the scanner 1 to cause the user to perform the confirmation operation. In the present embodiment, the details of the confirmation operation are notified to the scanner 1 by (transmitted to the scanner 1 from) the user terminal 3. The details of the confirmation operation may be held in the scanner 1 in advance. The details of the confirmation operation may be fixed or may be set to be dynamically changeable by at least the own apparatus (scanner 1) or the user terminal 3 according to at least one of a user characteristic, the details of settings of the own apparatus, a function of the own apparatus, the details of settings of the user terminal 3, and a function of the user terminal 3. For example, for a user who is using audio accessibility settings (such as enabling the display of subtitles), a confirmation operation that relies on hearing, such as the confirmation operation 7, is inconsiderable. Therefore, the confirmation operation may be changed (switched) to another confirmation operation (details of another confirmation operation) instead of the confirmation operation 7. As described above, the confirmation operation to be performed by the user may be changed according to a user characteristic, the details of settings of the user terminal 3, etc. As a result, the details of the confirmation operation to be performed by the user can be optimally set according to a user characteristic, the details of settings, etc. Further, when the confirmation operation details are dynamically changed according to the functions (display function, input function, etc.) of the scanner 1 and the functions (display function, input function, etc.) of the user terminal 3, the confirmation procedure can be performed by the existing hardware of the scanner 1 and the user terminal 3. This has the effect of reducing the cost of preparing additional hardware.

The first display control unit 24 controls display performed via the output device 16 of the own apparatus (scanner 1). For example, the first display control unit 24 may display the information on the confirmation operation received by the operation notification reception unit 23 via the output device 16.

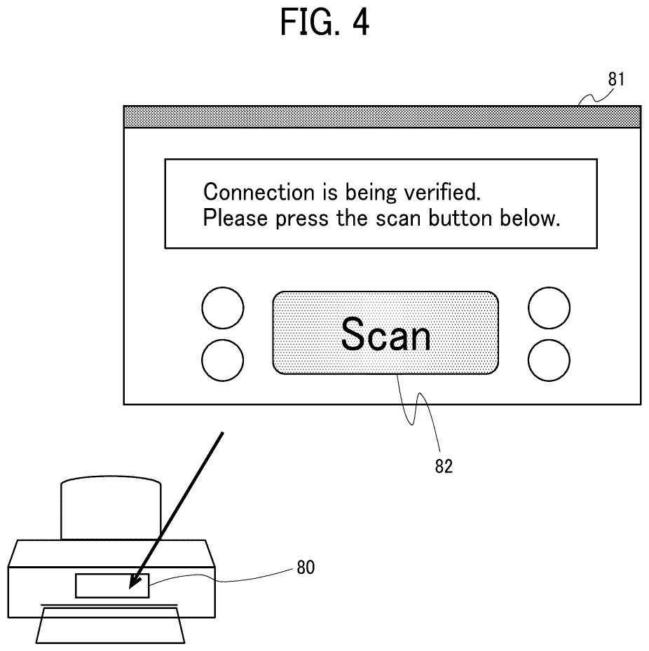

FIG. 4 is a diagram illustrating an example of display of information on the confirmation operation according to the present embodiment. FIG. 4 illustrates a confirmation operation instruction screen 81 displayed on a display 80 (output device 16) of the scanner 1. For example, when the operation notification reception unit 23 receives the information on the confirmation operation, the confirmation operation instruction screen 81 is displayed on the display 80 (output device 16) of the scanner 1. As illustrated in FIG. 4, the confirmation operation instruction screen 81 displays a message “Please press the scan button below” as a message instructing to perform the confirmation operation. To distinguish from a scan standby screen to be displayed on the display 80 of the scanner 1, the color of a button related to the confirmation operation (e.g., a scan button 82) may change from the usual one or the button may be caused to blink, during the waiting time for the confirmation operation, in addition to the message illustrated in FIG. 4. However, the confirmation operation instruction screen displayed on the scanner 1 is not limited to the example of FIG. 4, and may be a screen including any components.

The confirmation operation instruction screen 81 displaying information such as the details of the confirmation operation allows the user to visually recognize the information and perform the confirmation operation (e.g., pressing the scan button 82) appropriately. This also allows the user to check whether the scanner paired with the user terminal 3 is the right scanner. Specifically, since the scanner 1 displaying a message instructing the confirmation operation is a scanner that has been paired with the user terminal 3, the user can check whether the scanner paired with the user terminal 3 is the right scanner by checking whether the message is displayed on a display of the right scanner. This can prevent the user from performing the confirmation operation for the incorrectly selected scanner. When the user is notified of the information on the confirmation operation via the user terminal 3 (the user notification unit 45), whether to display the information on the confirmation operation on the scanner 1 may be set optionally.

The first display control unit 24 may cause the output device 16 to display information on the check result obtained by the first check unit 27. For example, the information on the check result displayed by the output device 16 may be information indicating the execution status of the confirmation operation, such as a reminder indicating that the confirmation operation has not performed, or a pairing result (success or failure). Further, a check result obtained by the first check unit 27 (e.g., information indicating that the own apparatus is not the right scanner) may be displayed. The first display control unit 24 may also display help information on how to perform the confirmation operation. Displaying information such as a pairing result or help information as described above can create a user-friendly announcement, thereby enhancing user convenience. The first display control unit 24 may operate to control display via the output device 36 of the user terminal 3. When the scanner 1 does not include the output device 16, the scanner 1 may not include the first display control unit 24.

The output unit 25 performs a predetermined output. The output unit 25 performs a predetermined output related to the confirmation operation in response to receiving information on the confirmation operation by the operation notification reception unit 23. For example, output processing may be performed in response to receiving, by the operation notification reception unit 23, the details of the output processing to be performed by the scanner 1, the instruction thereof, etc., for causing the user to perform the confirmation operation. Alternatively, for example, output processing pre-stored in the scanner 1 as the predetermined output related to the confirmation operation may be performed in response to receiving a signal indicating an instruction causing the user to perform the confirmation operation by the operation notification reception unit 23. In the present embodiment, the output unit 25 performs the predetermined output after the pairing between the own apparatus and the user terminal 3 is completed. For example, the predetermined output may be at least one of output of a specific light, display of a specific screen, output of a specific sound, and generation of a specific vibration. The output of a specific light may be, for example, blinking of a specific lamp (e.g., a lamp indicating that a WI-FI (registered trademark) status is on, or a lamp integrated with a scan button) in a specific color. The display of a specific screen may include display of the confirmation operation instruction screen 81 (see FIG. 4) by the first display control unit 24. In this case, the output unit 25 may function as the first display control unit 24. The output of a specific sound may be, for example, generation (output) of sound by operating a motor or a roller in the scanner for a purpose other than document conveyance. Outputting sound using a mechanism such as a motor or a roller that is typically mounted on a scanner can perform sound output (output a notification to the user) without adding another hardware component such as a speaker. However, the output of a specific sound may be performed by other hardware components such as a speaker generating a beep. The generation of a specific vibration may be performed by, for example, causing a motor to operate. However, the predetermined output is not limited to the above-described examples and can be set to any desired output. When the confirmation operations 6 or 7 is not adopted as a confirmation operation to be performed by the user, the scanner 1 may not include the output unit 25.

The identification information notification unit 26 notifies the user terminal 3 of identification information that can identify the own apparatus (scanner 1). The identification information may be an individual number such as serial numbers or information such as specific light-emitting diode (LED) blinking cycles, but may be any information that can identify the scanner 1 (individual apparatus). For example, the identification information notification unit 26 may notify the user terminal 3 of the identification information held (stored) in the scanner 1. When the confirmation operation 8 is not adopted as a confirmation operation to be performed by the user, the scanner 1 may not include the identification information notification unit 26.

The first check unit 27 checks whether the confirmation operation (first predetermined operation) has been performed related to the own apparatus after the pairing between the user terminal 3 and the own apparatus (scanner 1) is completed, or whether information input by the confirmation operation (second predetermined operation) performed after the pairing is completed meets a predetermined condition. A check process performed by the first check unit 27 when the confirmation operation to be instructed to the user is one of the confirmation operations 1 to 8 (see FIG. 3) is described below in detail.

### Cases of Confirmation Operations 1 to 5

The first check unit 27 checks whether the confirmation operation has been performed related to (on or for) the own apparatus (scanner 1). In the case of the confirmation operation 1, the first check unit 27 checks whether a button of the own apparatus is pressed. In the case of the confirmation operation 2, the first check unit 27 checks whether a medium such as a document is placed on the own apparatus (or whether the scan button is pressed after the medium is placed). In the case of the confirmation operation 3, the first check unit 27 checks whether the own apparatus has been restarted. In the case of the confirmation operation 4, the first check unit 27 checks whether the range between the own apparatus and the user terminal 3 is equal to or less than a predetermined range (e.g., 10 cm) (whether an operation (action) of bringing the user terminal 3 closer to the own apparatus is performed, that is, whether the user terminal 3 has approached the own apparatus). For example, the first check unit 27 can measure the distance between the user terminal 3 and the own apparatus by using radio waves emitted from a signal emitting unit of the user terminal 3 and can be used for distance measurement, and the first check unit 27 checks whether the measured distance is equal to or less than a predetermined distance. In the case of the confirmation operation 5, the first check unit 27 checks whether the user terminal 3 has established NFC communication with the own apparatus (whether NFC communication has been established between the user terminal 3 and the own apparatus). For example, the first check unit 27 checks whether an operation (action) of bringing the user terminal 3 into contact, which is an operation for establishing NFC communication, has been performed on the own apparatus (for the own apparatus).

In the cases of the confirmation operations 1 to 5, whether the confirmation operation has been performed related to the own apparatus (scanner 1) can be checked by detecting whether the confirmation operation has been performed related to the own apparatus. In this case, the first check unit 27 notifies (transmits) the check result (information indicating whether the confirmation operation has been performed) to the user terminal 3. In the case of the confirmation operations 4 or 5, the user terminal 3 also can detect whether the confirmation operation has been performed related to the scanner 1. For example, the user terminal 3 can measure the distance between the own device (user terminal 3) and the scanner 1 by using a signal emitted from the scanner 1 that has completed pairing with the user terminal 3. In this case, the user terminal 3 can detect that the distance between the scanner 1 that has completed pairing with the own device is equal to or less than a predetermined distance. The user terminal 3 can detect whether NFC communication is established between the scanner 1 and the own device (whether the scanner 1 and the user terminal 3 are in contact with each other). In such a case, the first check unit 27 may check whether the confirmation operation has been performed related to the own apparatus by receiving the result detected by the user terminal 3 from the user terminal 3 (second check unit 49). As described above, in each of the confirmation operations 1 to 5, whether the right scanner has been paired is checked depending on whether the confirmation operation has been performed related to the own apparatus (scanner 1 that has completed the pairing).

### Cases of Confirmation Operations 6 and 7

The first check unit 27 checks whether information input by the confirmation operation (input operation of inputting a user confirmation result indicating whether the user has confirmed that a predetermined output is performed by the right scanner) meets a predetermined condition. Specifically, the first check unit 27 checks whether the user confirmation result input by an input operation indicates that the predetermined output performed by the right scanner has been confirmed. In the present embodiment, the predetermined output (e.g., output of a specific light, output of a specific sound) is performed by the scanner 1 that has completed the pairing with the user terminal 3, and when the user confirms that the predetermined output is performed by the right scanner, the user also can confirm that the pairing with the right scanner has been completed.

In the case of the confirmation operations 6 or 7, the user terminal 3 may receive a user input operation of inputting a user confirmation result, and the user terminal 3 (the second check unit 49 described later) may check whether the user confirmation result indicates that the predetermined output performed by the right scanner has been confirmed. In this case, the first check unit 27 receives a check result obtained by the user terminal 3 from the user terminal 3 (second check unit 49). Thus, the first check unit 27 can check whether the user confirmation result indicates that the predetermined output performed by the right scanner 1 has been confirmed. The first check unit 27 may receive the user confirmation result from the user terminal 3 (second check unit 49) and check whether the user confirmation result indicates that the predetermined output performed by the right scanner 1 has been confirmed. As another method, the user confirmation result may be input to (select at) the scanner 1 that has completed the pairing, by causing the user to input the user confirmation result to the scanner 1. In this case, the first check unit 27 may receive the user confirmation result input to the own apparatus (scanner 1) and check whether the user confirmation result indicates that the predetermined output performed by the right scanner has been confirmed. In this case, the first check unit 27 notifies the user terminal 3 of the check result (transmits the check result to the user terminal 3).

### Case of Confirmation Operation 8

The first check unit 27 checks whether information input by the confirmation operation (imaging operation of imaging the right scanner) meets a predetermined condition. Specifically, the first check unit 27 checks whether information (e.g., a serial number included in the captured image, or a specific blinking cycle of the LED included in the captured moving image) input by the imaging operation is identical to (matches) identification information (e.g., an individual number, or a specific blinking cycle of the LED) for identifying the own apparatus (scanner 1).

In the case of the confirmation operation 8, the user terminal 3 (the identification information reception unit 47) can receive identification information for identifying the scanner 1 from the scanner 1 (the identification information notification unit 26) that notifies the user terminal 3 of the identification information. Further, the user terminal 3 (the identification information acquisition unit 48) can acquire the identification information of the scanner 1 according to a user operation for imaging the right scanner (the scanner that the user thinks the user has selected) using the user terminal 3. Then, the user terminal 3 (second check unit 49) compares the identification information received from the scanner 1 with the identification information input by the imaging operation performed by the user, thereby checking whether the information input by the imaging operation is identical to the identification information for identifying the scanner 1. In this case, the first check unit 27 receives the check result obtained by the second check unit 49 or the information input by the imaging operation from the user terminal 3 (second check unit 49), and can check whether the information input by the imaging operation performed by the user is identical to the identification information for identifying the own apparatus. As described above, in each of the confirmation operations 6 to 8, whether the information input by the confirmation operation indicates that the right scanner is paired is checked. That is, whether the right scanner is paired is checked based on the information input by the confirmation operation.

As described above, by performing the check process performed by the first check unit 27, the scanner 1 can check whether the own apparatus that has completed pairing with the user terminal 3 is the right scanner intended by the user who uses the user terminal 3, that is, whether the connection destination (pairing destination) is correct.

The first check unit 27 may omit the check process when a determination unit determines that a predetermined condition for omitting the check process (predetermined omission condition) is met before the first check unit 27 performs the check process. That is, when the predetermined omission condition is met, the instruction to perform the confirmation operation is not given to the user. For example, the predetermined omission condition is a condition related to a positional relationship between the own apparatus and the user terminal 3 or a condition related to the type of the user terminal 3. For example, the first check unit 27 may omit the check process when the user terminal 3 is detected within the predetermined distance from (or very close to) the own apparatus, namely, when the distance from the own apparatus to the user terminal 3 is determined to be equal to or less than the predetermined distance, before the first check unit 27 performs the check process. Further, for example, when the first check unit 27 detects that the user terminal 3 is a mobile terminal before performing the check process, the first check unit 27 may omit the check process. As a result, the confirmation operation performed by the user after the completion of pairing is no longer required, making the procedure for pairing easier.

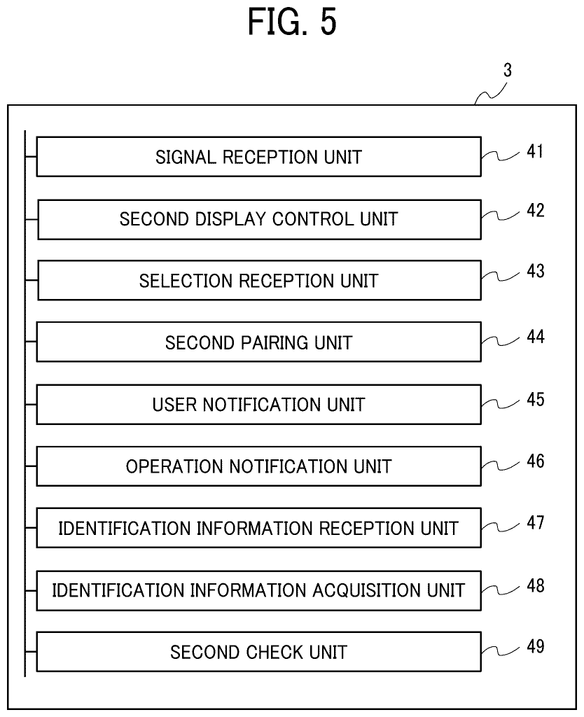

FIG. 5 is a schematic diagram illustrating a functional configuration of the information processing device (user terminal) 3 according to the present embodiment. The CPU 31 executes a program loaded onto the RAM 33 from the storage device 34, to control the hardware components of the information processing device 3. Thus, the information processing device 3 functions as an apparatus including a signal reception unit 41, a second display control unit 42 (corresponding to the “display control unit” of the information processing device 3 of the present application), a selection reception unit 43, a second pairing unit 44 (corresponding to the “pairing unit” of the information processing device 3 of the present application), a user notification unit 45, an operation notification unit 46, an identification information reception unit 47, an identification information acquisition unit 48, and a second check unit 49 (corresponding to the “check unit” of the information processing device 3 of the present application). In the present embodiment and other embodiments described below, the functions of the information processing device 3 are executed by the CPU 31 which is a general-purpose processor. Alternatively, a part or all of these functions may be executed by one or multiple dedicated processors.

The signal reception unit 41 receives advertising emitted by the scanner 1 (emitting unit 21). Accordingly, the user terminal 3 can acquire information on nearby electronic apparatuses, and can recognize what kinds of electronic apparatuses are present in the vicinity. In the present embodiment, the advertising received from the scanner 1 includes the service UUID (UUID A) for identifying Just Works. The signal reception unit 41 discovers a nearby electronic apparatus by scanning (receiving) advertising, and the scanning by the signal reception unit 41 may be passive scanning or active scanning.

The second display control unit 42 displays information on connectable scanners (e.g., a list of connectable scanners) via the output device 36. The second display control unit 42 displays information on the scanners 1 (e.g., the scanner 1a, the scanner 1b, and the scanner 1c illustrated in FIG. 1), which are sources of the advertising received by the signal reception unit 41.

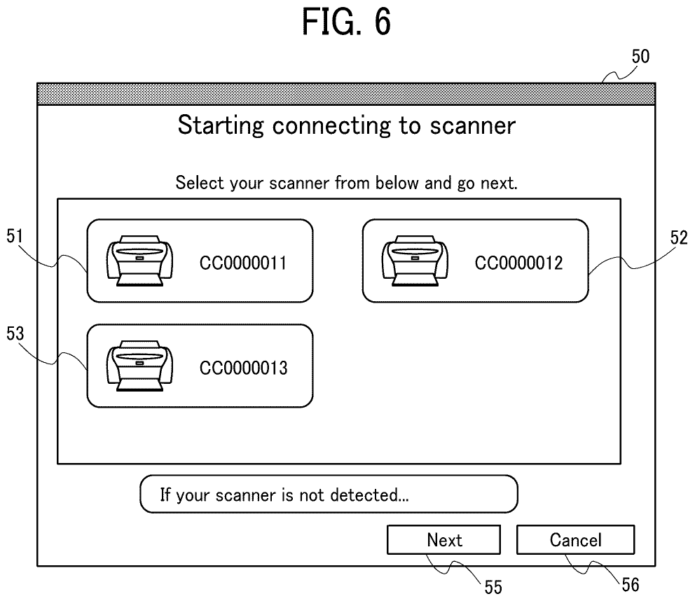

FIG. 6 is a diagram illustrating an example of a screen displaying a list of connectable scanners according to the present embodiment. FIG. 6 illustrates the scanner selection screen 50 displayed on the display (output device 36) of the user terminal 3. For example, the scanner selection screen 50 is displayed on the display (output device 36) of the user terminal 3, when a scanner application (such as an initial settings wizard) is started according to a user operation performed on the user terminal 3. As illustrated in FIG. 6, the scanner selection screen 50 includes information on the connectable scanners 1 (three scanners (the scanner 1a, the scanner 1b, and the scanner 1c) that are the sources of the advertising received by the signal reception unit 41). Specifically, the scanner selection screen 50 includes a display component 51 indicating information on the scanner 1a, a display component 52 indicating information on the scanner 1b, and a display component 53 indicating information on the scanner 1c. Each of the display components 51, 52, and 53 may include any information such as a product name, an identification number, and an exterior diagram (exterior photo) of the corresponding scanner 1. However, the scanner selection screen is not limited to the example of FIG. 6, and may be a screen including any components.

Further, the second display control unit 42 may display a message indicating that pairing is to be performed again via the output device 36 when the confirmation operation is not successful, and the pairing is canceled after the confirmation operation. For example, a message instructing the user to select another scanner, to perform a confirmation operation (a confirmation operation that is the same as or different from the previously instructed confirmation operation), or to select the same scanner again and then perform a confirmation operation (a confirmation operation that is the same as or different from the previously instructed confirmation operation) may be displayed. For example, the message may be displayed in the initial settings wizard of the scanner application. Thus, even when the user selects a wrong scanner that is not intended by the user, the user can immediately notice the mistake. This allows the user to smoothly select a scanner again and perform pairing again.

The selection reception unit 43 receives selection of a scanner to be wirelessly connected to the user terminal 3 according to the first wireless communication standard (BLUETOOTH). The selection reception unit 43 receives a user operation for selecting a scanner to be wirelessly connected. In the present embodiment, the user operation for selecting a scanner is received on the scanner selection screen 50 illustrated in FIG. 6. For example, when the user selects the display component 51 and then presses a button for proceeding with the process (“Next” button 55 in FIG. 6), the selection reception unit 43 receives the selection of the scanner 1a as a scanner to be connected to the user terminal 3. When a button for canceling the scan selection (the “Cancel” button 56 in FIG. 6) is pressed on the scanner selection screen 50, the scanner selection screen 50 may be closed.

The second pairing unit 44 transmits a pairing request for wireless communication in accordance with the first wireless communication standard (BLUETOOTH) to the selected scanner 1. The second pairing unit 44 transmits a pairing request to the scanner (scanner 1a in the case of the above example) for which the selection has been received by the selection reception unit 43. The second pairing unit 44 specifies (stores) the service UUID (UUID A) for identifying Just Works included in the advertising emitted from the selected scanner before transmitting the pairing request. As with the scanner 1, the user terminal 3 may also pre-store the service UUID and information indicating what service the service UUID identifies in association with each other, as the scanner 1. For example, the UUID A and the service “Just Works” may be stored in association with each other. The second pairing unit 44 receives a pairing response from the scanner 1. The second pairing unit 44 cancels pairing as appropriate. In this way, the second pairing unit 44 performs various processing related to pairing (which may include, in addition to the above-described processing, exchanging encrypted information (encryption key)). When the “Next” button 55 in FIG. 6 is pressed, the selection of the scanner to be connected to the user terminal 3 may be accepted, and the pairing request may be transmitted to the selected scanner 1 by the second pairing unit 44, and the pairing with the scanner 1 may be completed.

The user notification unit 45 outputs a notification to notify the user of various information. For example, the user notification unit 45 outputs a notification (instruction) to notify the user of information on the confirmation operation or to instruct the user to perform the confirmation operation along with information on the confirmation operation. The information on the confirmation operation includes the details of the confirmation operation and the time limit of the confirmation operation. For example, the user notification unit 45 outputs a notification to notify the user of the details of the confirmation operation (operation instruction) by displaying a message instructing the user to perform the confirmation operation within a certain time (e.g., 30 seconds) via the output device 36.

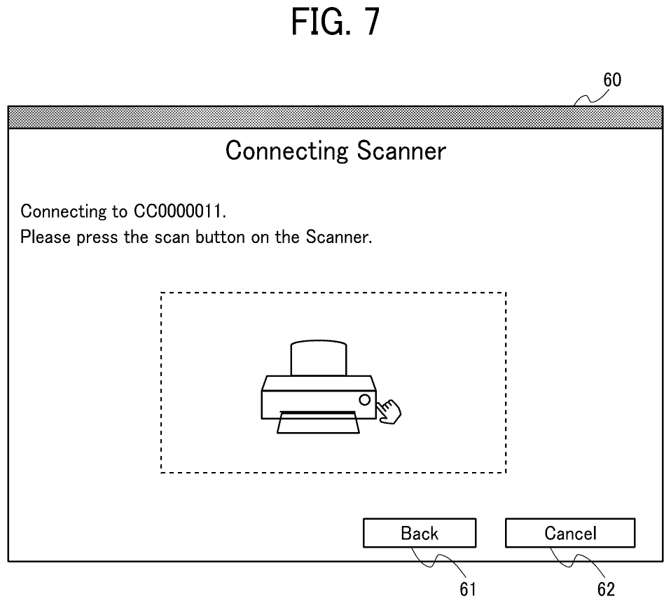

FIG. 7 is a diagram illustrating a first example of the confirmation operation instruction screen according to the present embodiment. FIG. 7 illustrates a confirmation operation instruction screen 60 displayed on the display (output device 36) of the user terminal 3. For example, the confirmation operation instruction screen 60 is displayed on the user terminal 3 when the “Next” button 55 is pressed on the scanner selection screen 50 (see FIG. 6). As illustrated in FIG. 7, a message “Please press the scan button” is displayed on the confirmation operation instruction screen 60, as a message instructing to perform the confirmation operation. This allows the user to visually recognize information including the details of the confirmation operation on the confirmation operation instruction screen 60 and appropriately perform the confirmation operation accordingly. The confirmation operation instruction screen 60 may include a button (“Back” button 61 in FIG. 7) for returning to the scanner selection screen 50 (see FIG. 6) to select a scanner again, and a button (“Cancel” button 62 in FIG. 7) for canceling connection with a scanner.

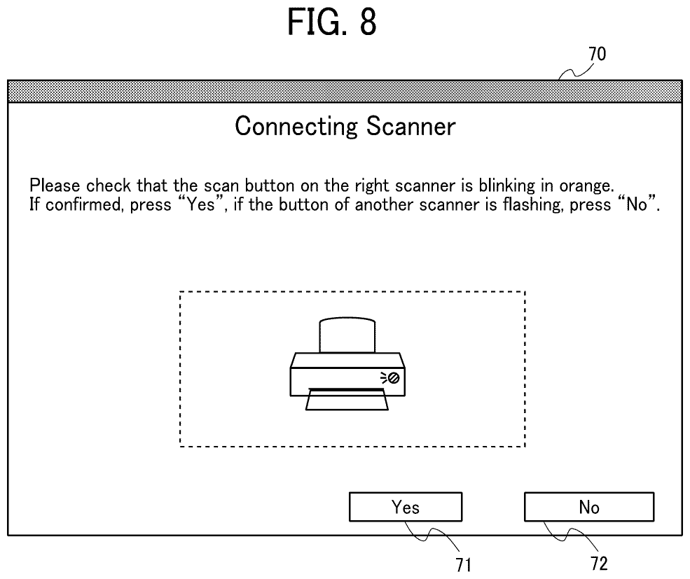

FIG. 8 is a diagram illustrating a second example of the confirmation operation instruction screen according to the present embodiment. FIG. 8 illustrates a confirmation operation instruction screen 70 displayed on the display (output device 36) of the user terminal 3. For example, the confirmation operation instruction screen 70 is displayed on the user terminal 3 when the “Next” button 55 is pressed on the scanner selection screen 50 (see FIG. 6). As illustrated in FIG. 8, the confirmation operation instruction screen 70 displays a message “Please check that the scan button on the right scanner is blinking in orange. If confirmed, press “Yes,” or if the button of another scanner is blinking, press “No,” as a message instructing to perform the confirmation operation. This allows the user to visually recognize information including the details of the confirmation operation on the confirmation operation instruction screen 70 and appropriately perform the confirmation operation accordingly. The confirmation operation instruction screen 70 includes a button (“YES” button 71 in FIG. 8) for inputting a result indicating that the user has confirmed a predetermined output (orange blinking of the scan button) of the right scanner (receiving a check result of the user), and a button (“NO” button 72 in FIG. 8) for inputting a result indicating that the user has failed to confirm that a predetermined output of the right scanner. However, the confirmation operation instruction screen displayed on the user terminal 3 is not limited to the examples of FIGS. 7 and 8, and may be a screen including any components.

The user notification unit 45 outputs a notification to notify the user that the pairing between the user terminal 3 and the scanner 1 (right scanner) has been completed (succeeded) or the pairing between the user terminal 3 and the scanner 1 (right scanner) has failed. Any suitable method may be used for the notification. For example, the notification to notify the user of information including the details of the confirmation operation or the result of pairing (success or failure) may be output by displaying the information via the output device 36 or output by voice. The user notification unit 45 may also display additional information such as help information explaining a way to perform the confirmation operation. Displaying information such as a pairing result or help information as described above can create a user-friendly announcement, thereby enhancing user convenience.

The operation notification unit 46 notifies the scanner 1 of information on the confirmation operation, namely transmits the information on the confirmation operation to the scanner 1. The information on the confirmation operation output or transmit by the operation notification unit 46 includes the details of the confirmation operation and a time for waiting for the confirmation operation (waiting time). In the case of the confirmation operations 6 to 8, the information on the confirmation operation may include the details (instruction) of output processing or identification information-transmission processing to be performed by the scanner 1 to cause the user to perform the confirmation operation.

The identification information reception unit 47 receives identification information from the scanner 1. The identification information reception unit 47 receives the identification information for identifying the scanner 1. The identification information is transmitted from the identification information notification unit 26. When the confirmation operation 8 is not adopted as a confirmation operation to be performed by the user, the user terminal 3 may not include the identification information reception unit 47.

The identification information acquisition unit 48 acquires the identification information of the scanner 1 as an imaging target by performing an imaging process (image capturing process) via the input device 35 (e.g., camera). In the present embodiment, the identification information acquisition unit 48 performs an imaging process in response to a user operation of imaging operation (an operation for imaging the right scanner 1) performed with the user terminal 3. For example, when the user performs an imaging operation to capture an image of a portion to which the individual number sticker is attached of the right scanner 1, the identification information acquisition unit 48 acquires a captured image in which the individual number of the right scanner 1 is captured. In the present embodiment, the identification information acquisition unit 48 acquires identification information (e.g., text information such as a serial number (individual number) of the scanner 1) included in the captured image by performing optical character recognition (OCR) on the captured image obtained by the imaging process. When the confirmation operation 8 is not adopted as a confirmation operation to be performed by the user, the user terminal 3 may not include the identification information acquisition unit 48.

The second check unit 49 checks whether the confirmation operation (first predetermined operation) has been performed related to the scanner 1 after the pairing between the own device (user terminal 3) and the scanner 1 is completed, or whether information input by the confirmation operation (second predetermined operation) performed after the pairing is completed meets a predetermined condition. A check process performed by the second check unit 49 when the confirmation operation to be instructed to the user is one of the confirmation operations 1 to 8 (see FIG. 3) is described below in detail.

### Cases of Confirmation Operations 1 to 5

The second check unit 49 checks whether the confirmation operation has been performed related to (on or for) the scanner 1 that has completed pairing (the scanner for which the selection is received by the selection reception unit 43). The details of the check process performed by the second check unit 49 is substantially the same as that performed by the first check unit 27. In the cases of the confirmation operations 1 to 5, the scanner 1 can check whether the confirmation operation has been performed related to the own apparatus by detecting whether the confirmation operation has been performed related to the own apparatus. In this case, the second check unit 49 checks whether the confirmation operation has been performed related to the scanner 1 that has completed the pairing by receiving a check result obtained by the scanner 1 (information indicating whether the confirmation operation has been performed) from the scanner 1. However, as described above, in the case of the confirmation operations 4 and 5, the user terminal 3 (second check unit 49) can also check whether the confirmation operation has been performed related to the scanner 1 that has completed the pairing by detecting, at the own device, whether the confirmation operation has been performed related to the scanner 1. In this case, the second check unit 49 notifies the scanner 1 of the check result (information indicating whether the confirmation operation has been performed), namely, transmits the check result to the scanner 1.

### Cases of Confirmation Operations 6 and 7

The second check unit 49 checks whether information input by the confirmation operation (input operation of inputting a user confirmation result indicating whether the user has confirmed that a predetermined output is performed by the right scanner) meets a predetermined condition. The details of the check process performed by the second check unit 49 is substantially the same as that performed by the first check unit 27. In the case of the confirmation operations 6 or 7, the user terminal 3 (second check unit 49) receives a user input operation of inputting a user confirmation result to check whether the user confirmation result indicates that the predetermined output performed by the right scanner has been confirmed. In this case, the second check unit 49 notifies the scanner 1 of the check result or the user confirmation result, namely, transmits the check result or the user confirmation result to the scanner 1. However, as described above, as another method, the user confirmation result may be input to (select at) the scanner 1 that has completed the pairing, by causing the user to input the user confirmation result to the scanner 1. In this case, the second check unit 49 may check whether the user confirmation result indicates that the predetermined output performed by the right scanner has been confirmed, by receiving, from the scanner 1 (first check unit 27), the user confirmation result or a result obtained by checking whether the user confirmation result indicates that the predetermined output performed by the right scanner has been confirmed.

### Case of Confirmation Operation 8

The second check unit 49 checks whether information input by the confirmation operation (imaging operation of imaging the right scanner) meets a predetermined condition. The details of the check process performed by the second check unit 49 is substantially the same as that performed by the first check unit 27. In the case of the confirmation operation 8, the user terminal 3 (second check unit 49) compares the identification information received from the scanner 1 with the identification information input by the imaging operation performed by the user, thereby checking whether the information input by the imaging operation is identical to the identification information for identifying the scanner 1. In this case, the second check unit 49 notifies the scanner 1 (first check unit 27) of the check result or the information input by the imaging operation, namely, transmits the check result or the information input by the imaging operation to the scanner 1.

As described above, by performing the check process performed by the second check unit 49, the user terminal 3 can check whether the scanner 1 that has completed pairing with the user terminal 3 is the right scanner intended by the user who uses the user terminal 3, that is, whether the connection destination (pairing destination) is correct. In substantially the same manner as the first check unit 27, the second check unit 49 may omit the check process when a predetermined omission condition is determined to be met before the second check unit 49 performs the check process.

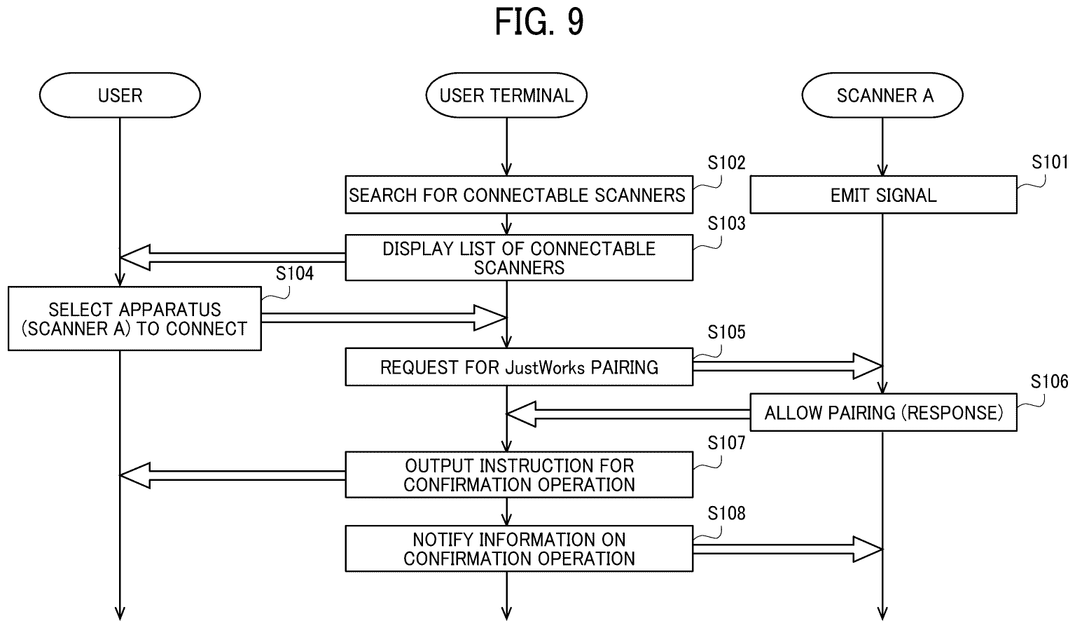

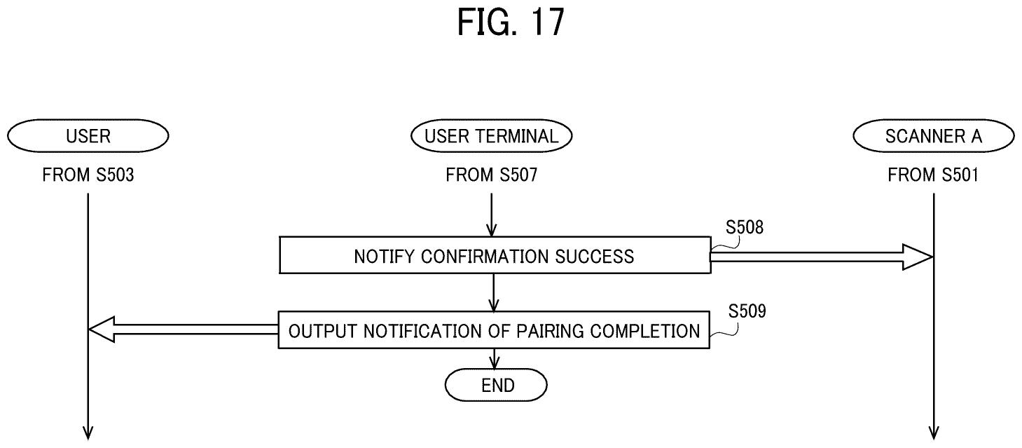

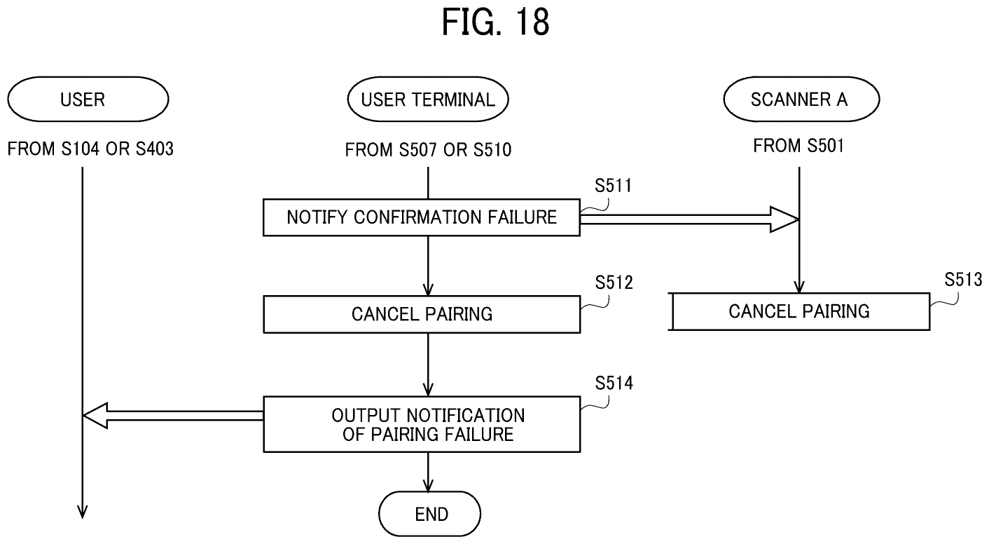

FIG. 9 is a flowchart and a communication sequence diagram illustrating an overview of a pairing process according to the present embodiment. In the present embodiment, the scanner 1 is assumed to either always allow BLUETOOTH pairing, or allow pairing to be established with a very simple operation (e.g., by long-pressing the BLUETOOTH icon). The process illustrated in the flowchart starts in response to a user operation performed on the user terminal 3 for starting a scanner application (such as an initial settings wizard). In FIGS. 9 to 18, the scanner 1 selected by the user in the scanner application, that is, the scanner 1 to be paired with the user terminal 3 is referred to as a “scanner A.” For example, the scanner A may be the scanner 1a of FIG. 1. Further, the “USER” in FIGS. 9 to 18 is the user of the “user terminal.”

In Steps S101 and S102, advertising (signal) is emitted from one or more scanners 1 (including the scanner A), and the user terminal 3 searches for a connectable scanner 1. In Step S101, the emitting unit 21 emits advertising. That is, the scanner 1 is available for connection. The emitting unit 21 may emit advertising before the scanner application is started by the user. The scanner 1 may periodically emit advertising. In Step S102, the signal reception unit 41 receives advertising from each scanner 1, and thereby searches for (detects) a connectable scanner. In the present embodiment, advertising including a service UUID (UUID A) for identifying Just Works is received from at least the scanner A. The process then proceeds to Step S103.

In Step S103, a list of connectable scanners 1 is displayed on the user terminal 3. The second display control unit 42 displays information on the scanners that are the emission sources of the advertising received in Step S102 (see FIG. 6). The process then proceeds to Step S104.

In Step S104, the user selects an apparatus to be connected. The user selects the scanner 1 to be wirelessly connected from the list of the scanners 1 displayed in Step S103. Accordingly, the selection reception unit 43 receives the selection of the scanner (scanner A) for wireless connection. The process then proceeds to Step S105.

In Step S105, the user terminal 3 transmits a pairing request. The second pairing unit 44 transmits a pairing request with the specified UUID A to the scanner (scanner A) selected in Step S104. The process then proceeds to Step S106.

In Step S106, pairing is allowed by the scanner A. The first pairing unit 22 receives the pairing request transmitted in Step S105, and performs pairing with Just Works between the own apparatus (scanner A) and the user terminal 3 based on the pairing request, and completes the pairing. At this time, the first pairing unit 22 transmits a pairing response to the user terminal 3. Thus, the pairing (based on the BLUETOOTH standard) is completed internally. Each of the scanner A and the user terminal 3 stores encrypted information generated and exchanged in the pairing. At this time, the user terminal 3 does not output a notification to notify the user of the pairing completion. The process then proceeds to Step S107.

In Step S107, the user terminal 3 outputs an instruction for the user to perform a confirmation operation. The user notification unit 45 outputs a notification (operation instruction) to notify the user of the details of the confirmation operation by displaying information on the confirmation operation (see FIGS. 7 and 8). The process then proceeds to Step S108.

In Step S108, the user terminal 3 notifies the scanner A of information on the confirmation operation. The operation notification unit 46 notifies (transmits) information on the confirmation operation to the scanner A. In Step S108, the first display control unit 24 may display the details of the confirmation operation on a display of the scanner A (see FIG. 4). For example, in the cases of the confirmation operations 1 to 5, the display of the scanner A displays information instructing to press the scan button, information instructing to place a sheet, information instructing to open and close the media tray cover, information indicating that distance measurement is being performed, information instructing to approach the scanner A, or information instructing to bring the user terminal 3 into contact with the scanner A. Further, for example, in the cases of the confirmation operations 6 and 7, the display of the scanner A displays information instructing to check whether a predetermined output (e.g., output of a specific light) is performed by the right scanner or information instructing to check whether the own apparatus is the right scanner. For example, in the case of the confirmation operation 8, the display of the scanner A displays information instructing to capture the identification information of the right scanner. The order of Step S107 and Step S108 may be reversed. Then, the process proceeds to Step S201, S301, S401, or S501 depending on the details of the confirmation operation.

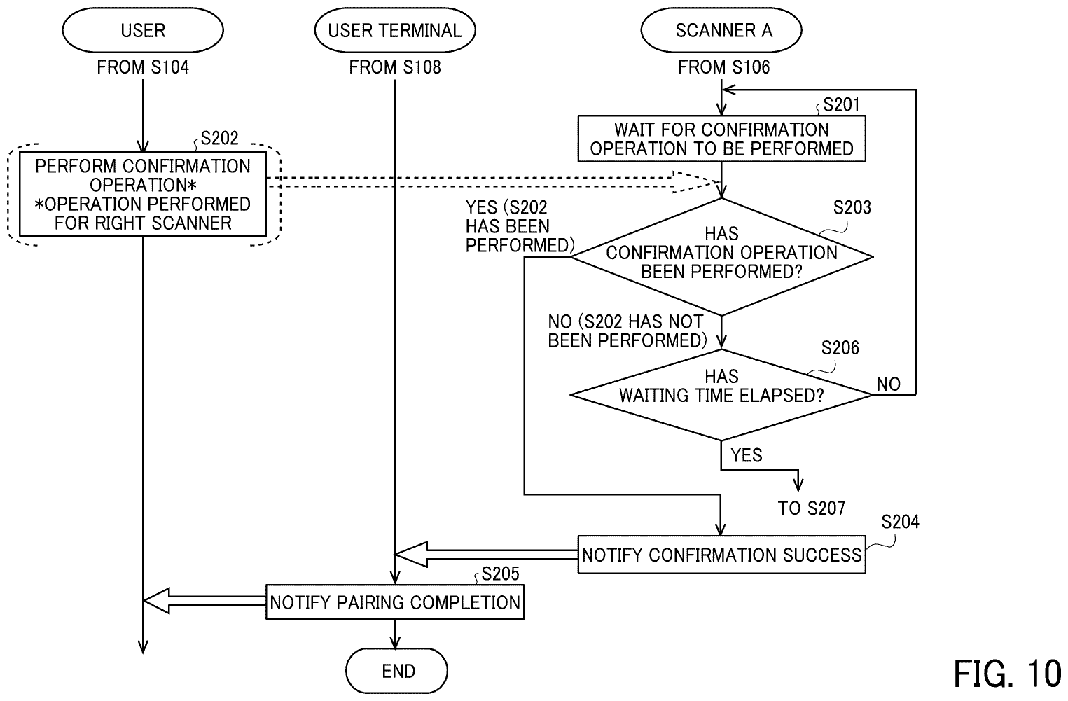

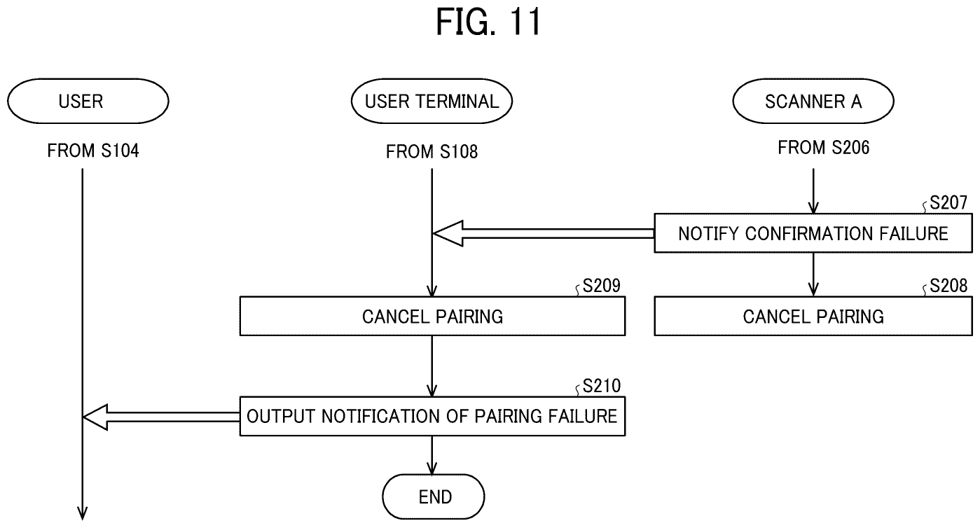

FIGS. 10 and 11 are flowcharts and communication sequence diagrams each illustrating an overview of a check process (in the cases of the confirmation operations 1 to 5 (when the scanner 1 detects that the confirmation operation has been performed)) according to the present embodiment. The process illustrated in the flowchart starts when the processing of Step S108 in FIG. 9 is performed, etc.

In Step S201, the scanner A waits for a confirmation operation to be performed. The first check unit 27 waits for the confirmation operation (operation to be performed related to the right scanner) of Step S202 to be performed by the user on (for) the own apparatus (scanner A). The user is instructed to perform the confirmation operation in Step S107, and thus performs the confirmation operation (Step S202). For example, the user performs an operation such as pressing a scan button on the right scanner, placing a document on the right scanner, or opening or closing a media tray cover of the right scanner. Alternatively, for example, the user performs an operation of bringing the user terminal 3 closer to the right scanner while holding it in hand. In this case, in Step S201, the scanner A that has completed the pairing with the user terminal 3 starts measuring the distance between the scanner A and the user terminal 3 using radio waves emitted from the user terminal 3. Alternatively, for example, the user performs an operation of bringing the user terminal 3 into contact with the right scanner. However, even when the confirmation operation is instructed, the confirmation operation (operation of Step S202) may not be performed for some reason. For this reason, the processing of Step S202 is represented by a dotted line in FIG. 10. The process then proceeds to Step S203.

In Step S203, the scanner A determines (checks) whether the confirmation operation has been performed. The details of the confirmation operation to be waited for by the scanner A may be stored in the scanner A in advance, or may be notified from the user terminal 3 to the scanner A in Step S108. The first check unit 27 checks whether the confirmation operation has been performed by detecting whether the confirmation operation has been performed related to the scanner A. When the first check unit 27 confirms (determines) that the confirmation operation has been performed (Yes in Step S203), the process proceeds to Step S204. In this case, since the right scanner is the scanner A, it can be determined that the confirmation operation has been performed for the scanner A. On the other hand, when the first check unit 27 fails to confirm that the confirmation operation is performed (No in Step S203), the process proceeds to Step S206.

In Step S204, the scanner A notifies the user terminal 3 of the confirmation success. The first check unit 27 notifies (transmits) information indicating that the confirmation operation has succeeded (the confirmation operation has been performed related to the scanner A, that is, the pairing has been established with the expected scanner) to the user terminal 3 as a check result obtained by the first check unit 27. The process then proceeds to Step S205.

In Step S205, the user terminal 3 outputs a notification of the pairing completion. The user notification unit 45 outputs a notification indicating that the pairing between the user terminal 3 and the right scanner intended by the user has been completed (succeeded) to notify the user of the pairing completion. After the pairing is completed and the BLUETOOTH communication is established, a setting (initial setting, etc.) for establishing a connection for wireless communication (second wireless communication) based on the second wireless communication standard (e.g., WI-FI) other than the first wireless communication standard between the scanner A and the user terminal 3 may be made using the BLUETOOTH communication. For example, the connection based on the second wireless communication may be established by a user operation performed on the user terminal 3 to transmit information such as a password or a service set identifier (SSID) for an access point to the scanner A. Further, an operation (e.g., a scanning process) of the scanner A using the second wireless communication may be performed by a user operation performed on the user terminal 3 after the second wireless communication is established. Then, the process illustrated in the flowchart ends.

In Step S206, the scanner A determines whether the waiting time has elapsed. The first check unit 27 determines whether a predetermined time (waiting time) has elapsed from a time such as when the pairing is completed. The waiting time may be stored in the scanner A in advance, or may be notified from the user terminal 3 to the scanner A in Step S108. When the waiting time has not elapsed (No in Step S206), the process returns to Step S201. On the other hand, when the waiting time has elapsed (Yes in Step S206), the process proceeds to Step S207.

In Step S207, the scanner A notifies the user terminal 3 of the confirmation failure. The first check unit 27 notifies (transmits) information indicating that the confirmation operation has failed (the confirmation operation has not been performed related to the scanner A, that is, the pairing has not been established with the expected scanner) to the user terminal 3 as a check result obtained by the first check unit 27. Assume that the scanner that the user expects to pair with (the right scanner) is a scanner B (e.g., scanner 1b), which is different from the scanner A. In this case, the confirmation operation by the user is performed related to (on or for) the scanner B. Alternatively, the confirmation operation by the user is not performed related to either the scanner A or the scanner B because the user understands that the scanner selection was made incorrectly by noticing that information on the confirmation operation such as an instruction for the confirmation operation is not displayed on the scanner B (because the information is displayed on the scanner A that has completed the pairing) when approaching the scanner B. That is, in such a case, the confirmation operation is not performed related to the scanner A, and the scanner A notifies the user terminal 3 of the confirmation failure. The process then proceeds to Steps S208 and S209.

In Steps S208 and S209, the pairing between the scanner A and the user terminal 3 is canceled. In Step S208, the first pairing unit 22 performs processing for canceling the pairing with the user terminal 3. In Step S209, the second pairing unit 44 performs processing for canceling the pairing with the scanner A. For example, the pairing information (the encrypted information stored by bonding, etc.) is deleted in the scanner A and the user terminal 3. The pairing cancellation may be performed by one of the apparatuses alone (the scanner A or the user terminal 3). The order of Step S208 and Step S209 may be reversed. The process then proceeds to Step S210.

In Step S210, the user terminal 3 outputs a notification of the pairing failure. The user notification unit 45 outputs a notification indicating that the pairing between the user terminal 3 and the right scanner intended by the user has failed to notify the user of the pairing failure. Then, the process illustrated in the flowchart ends.

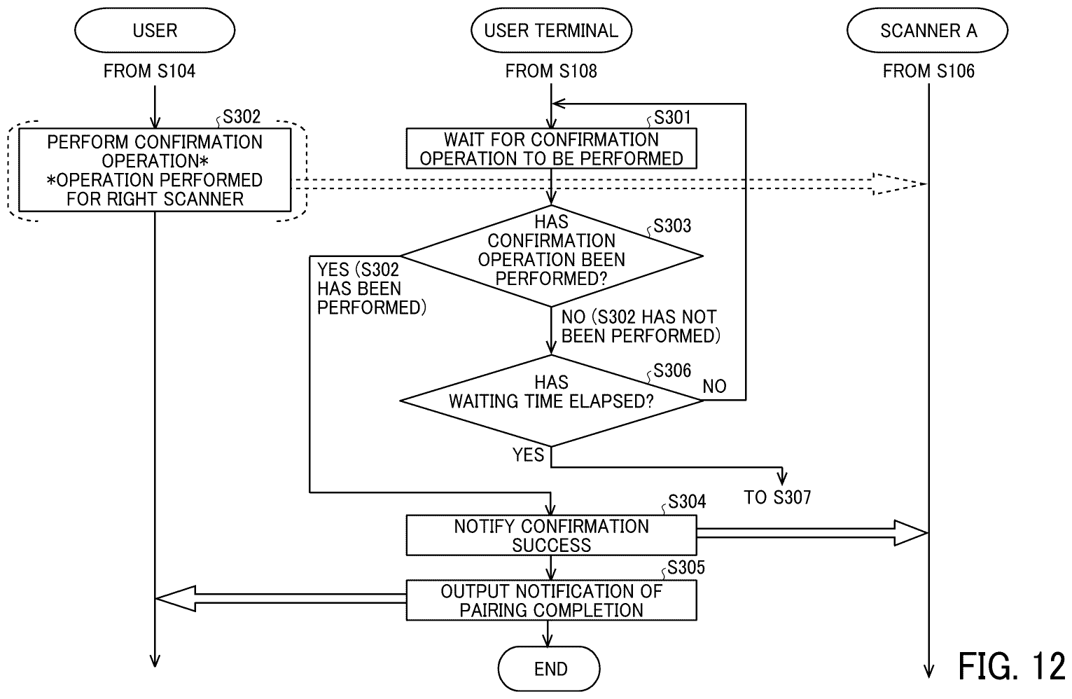

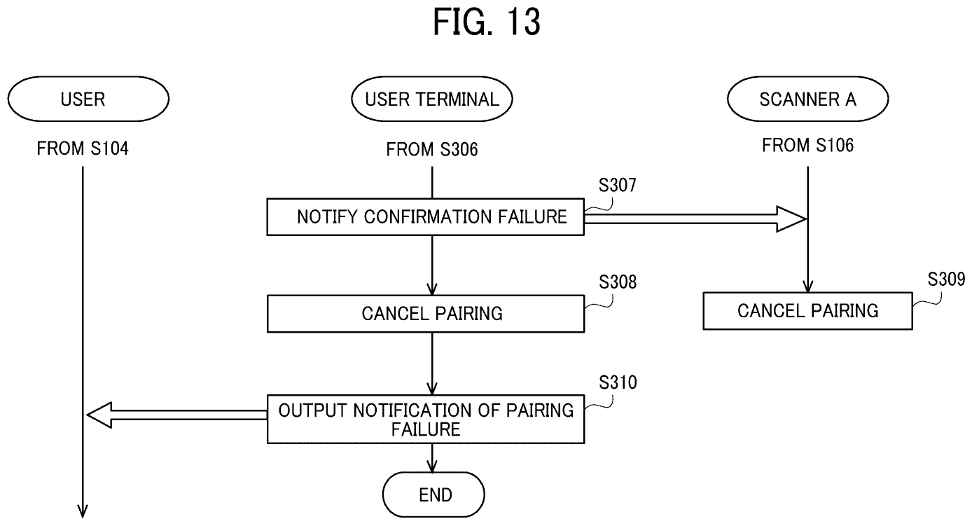

FIGS. 12 and 13 are flowcharts and communication sequence diagrams each illustrating an overview of a check process (in the cases of the confirmation operations 4 and 5 (when the user terminal 3 detects that the confirmation operation has been performed)) according to the present embodiment. The process illustrated in the flowchart starts when the processing of Step S108 in FIG. 9 is performed, etc.

In Step S301, the user terminal 3 waits for the confirmation operation to be performed. The second check unit 49 waits for the confirmation operation (operation to be performed related to the right scanner) of Step S302 to be performed by the user related to the scanner A that has completed the pairing. The user is instructed to perform the confirmation operation in Step S107, and thus performs the confirmation operation (Step S302). For example, the user performs an operation of bringing the user terminal 3 closer to the right scanner while holding it in hand. In this case, in Step S301, the user terminal 3 starts measuring the distance between the scanner A and the user terminal 3 using the radio waves emitted from the scanner A. However, even when the confirmation operation is instructed, the confirmation operation (operation of Step S302) may not be performed for some reason. For this reason, the processing of Step S302 is represented by a dotted line in FIG. 12. The process then proceeds to Step S303.

In Step S303, the user terminal 3 determines (checks) whether the confirmation operation has been performed. The second check unit 49 checks whether the confirmation operation has been performed by detecting whether the confirmation operation has been performed related to the scanner A. When the second check unit 49 determines or confirms that the confirmation operation has been performed (Yes in Step S303), the process proceeds to Step S304. On the other hand, when the second check unit 49 fails to confirm that the confirmation operation is performed (No in Step S303), the process proceeds to Step S306.

In Step S304, the user terminal 3 notifies the scanner A of the confirmation success. The second check unit 49 notifies (transmits) information indicating that the confirmation operation has succeeded (the confirmation operation has been performed related to the scanner A, that is, the pairing has been established with the expected scanner) to the scanner A as a check result obtained by the second check unit 49. The process then proceeds to Step S305.

In Step S305, the user terminal 3 outputs a notification of the pairing completion. The processing of Step S305 is substantially the same as the processing of Step S205 in FIG. 10, and thus the description thereof is omitted. The order of Step S304 and Step S305 may be reversed. Then, the process illustrated in the flowchart ends.

In Step S306, the user terminal 3 determines whether the waiting time has elapsed. The second check unit 49 determines whether a predetermined time (waiting time) has elapsed from a time such as when the pairing is completed. When the waiting time has not elapsed (No in Step S306), the process returns to Step S301. On the other hand, when the waiting time has elapsed (Yes in Step S306), the process proceeds to Step S307.

In Step S307, the user terminal 3 notifies the scanner A of the confirmation failure. The second check unit 49 notifies (transmits) information indicating that the confirmation operation has failed (the confirmation operation has not been performed related to the scanner A, that is, the pairing has not been established with the expected scanner) to the scanner A as a check result obtained by the second check unit 49. The process then proceeds to Steps S308 and S309.

In Steps S308 and S309, the pairing between the scanner A and the user terminal 3 is canceled. The order of Step S308 and Step S309 may be reversed. The processing of Steps S308 and S309 is substantially the same as the processing of Steps S208 and S209 in FIG. 11, and thus the description thereof is omitted. The process then proceeds to Step S310.

In Step S310, the user terminal 3 outputs a notification of the pairing failure to notify the user of the pairing failure. The processing of Step S310 is substantially the same as the processing of Step S210 in FIG. 11, and thus the description thereof is omitted. Then, the process illustrated in the flowchart ends.

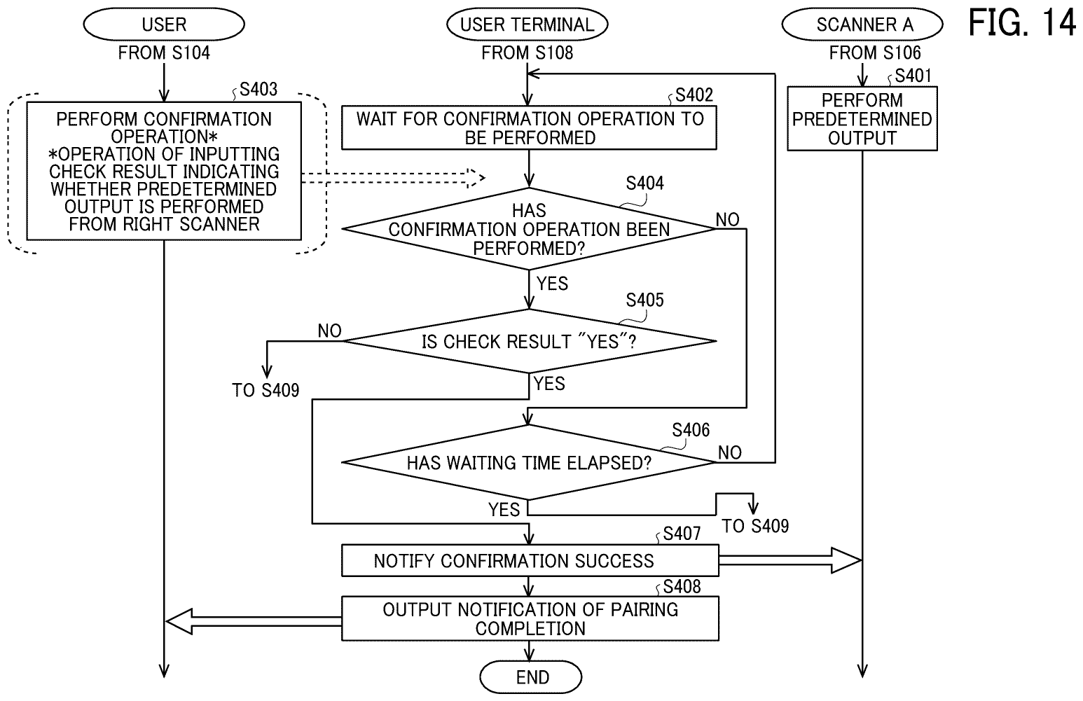

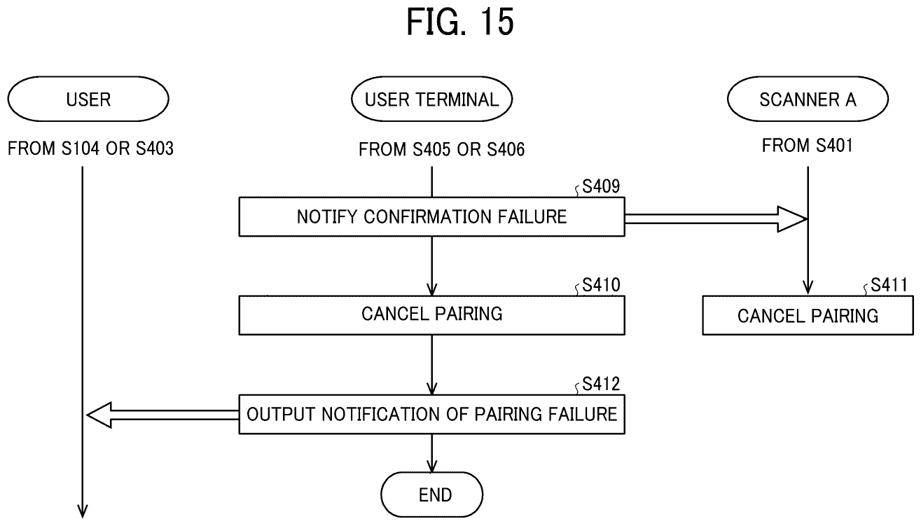

FIGS. 14 and 15 are flowcharts and communication sequence diagrams each illustrating an overview of a check process (in the cases of the confirmation operations 6 and 7) according to the present embodiment. The process illustrated in the flowchart starts when the processing of Step S108 in FIG. 9 is performed, etc.

In Step S401, the scanner A performs a predetermined output. The output unit 25 performs a predetermined output (such as displaying a specific screen or outputting a specific sound). The details of the predetermined output may be stored in the scanner A in advance, or may be notified from the user terminal 3 to the scanner A in Step S108.

In Step S402, the user terminal 3 waits for the confirmation operation to be performed. The second check unit 49 waits for the confirmation operation (operation of inputting a check result indicating whether a predetermined output is performed by the right scanner) of Step S403 to be performed by the user. The user is instructed to perform the confirmation operation in Step S107, and thus performs the confirmation operation (Step S403). However, even when the confirmation operation is instructed, the confirmation operation (operation of Step S403) may not be performed for some reason. For this reason, the processing of Step S403 is represented by a dotted line in FIG. 14. The order of Step S401 and Step S402 may be reversed. The process then proceeds to Step S404.

In Step S404, the user terminal 3 determines (checks) whether the confirmation operation has been performed. The second check unit 49 detects whether the confirmation operation (operation of inputting a check result indicating whether the predetermined output is performed by the right scanner) is performed, thereby checking whether the confirmation operation is performed. When the second check unit 49 determines or confirms that the confirmation operation has been performed (Yes in Step S404), the process proceeds to Step S405. On the other hand, when the second check unit 49 fails to confirm that the confirmation operation is performed (No in Step S404), the process proceeds to Step S406.

In Step S405, the user terminal 3 determines (checks) whether the input check result is “YES.” The second check unit 49 checks whether the check result input by the input operation is “YES” (a check result indicating that the predetermined output is performed by the right scanner). When the check result is “YES” (Yes in Step S405), the process proceeds to Step S407. On the other hand, when the check result is not “YES” (No in Step S405), the process proceeds to Step S409.

In Step S406, the user terminal 3 determines whether the waiting time has elapsed. The second check unit 49 determines whether a predetermined time (waiting time) has elapsed from a time such as when the pairing is completed. When the waiting time has not elapsed (No in Step S406), the process returns to Step S402. On the other hand, when the waiting time has elapsed (Yes in Step S406), the process proceeds to Step S409.

In Step S407, the user terminal 3 notifies the scanner A of the confirmation success. The second check unit 49 notifies (transmits) information indicating that the confirmation operation has succeeded (the check result indicating that the predetermined output is performed by the right scanner is input, that is, the pairing has been established with the expected scanner) to the scanner A as a check result obtained by the second check unit 49. The process then proceeds to Step S408.

In Step S408, the user terminal 3 outputs a notification of the pairing completion. The processing of Step S408 is substantially the same as the processing of Step S205 in FIG. 10, and thus the description thereof is omitted. The order of Step S407 and Step S408 may be reversed. Then, the process illustrated in the flowchart ends.

In Step S409, the user terminal 3 notifies the scanner A of the confirmation failure. The second check unit 49 notifies (transmits) information indicating that the confirmation operation has failed (the check result indicating that the predetermined output is not performed by the right scanner is input, that is, the pairing has not been established with the expected scanner) to the scanner A as a check result obtained by the second check unit 49. The process then proceeds to Steps S410 and S411.

In Steps S410 and S411, the pairing between the scanner A and the user terminal 3 is canceled. The order of Step S410 and Step S411 may be reversed. The processing of Steps S410 and S411 is substantially the same as the processing of Step S208 and Step S209 in FIG. 11, and thus the description thereof is omitted. The process then proceeds to Step S412.

In Step S412, the user terminal 3 outputs a notification of the pairing failure. The processing of Step S412 is substantially the same as the processing of Step S210 in FIG. 11, and thus the description thereof is omitted. Then, the process illustrated in the flowchart ends.

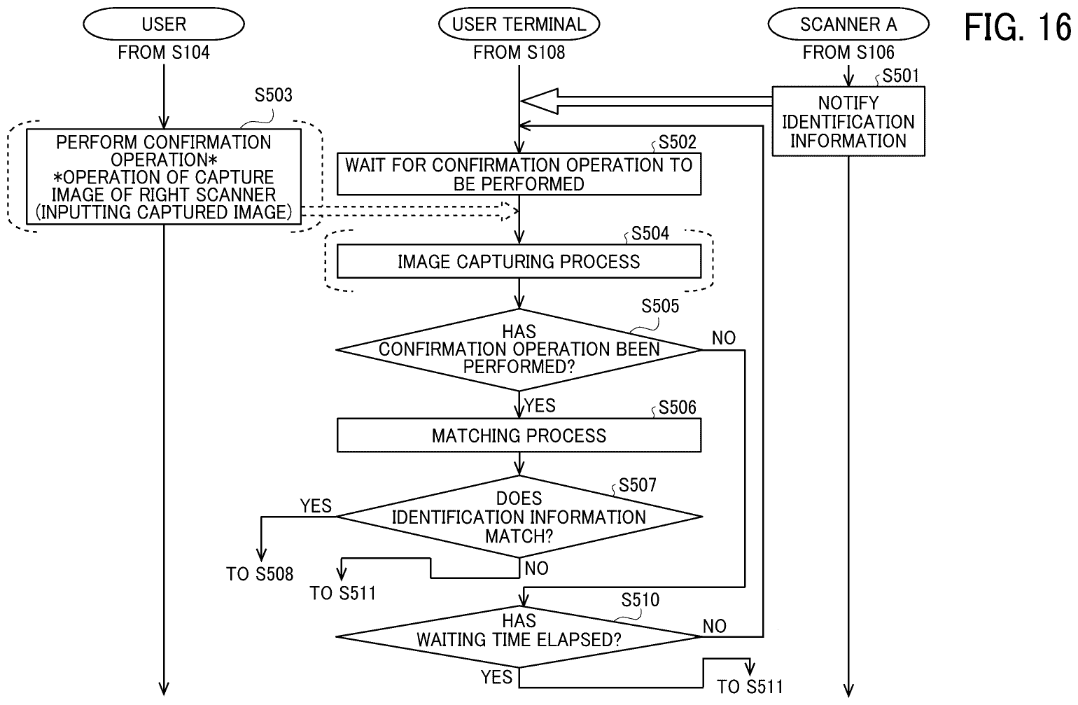

FIGS. 16 to 18 are flowcharts and communication sequence diagrams each illustrating an overview of a check process (in the case of the confirmation operation 8) illustrating an overview of a check process according to the present embodiment. The process illustrated in the flowchart starts when the processing of Step S108 in FIG. 9 is performed, etc.

In Step S501, the scanner A notifies the user terminal 3 of the identification information. The identification information notification unit 26 notifies the user terminal 3 of the identification information of the scanner A. Accordingly, the user terminal 3 (the identification information reception unit 47) receives the identification information of the scanner A. In Step S108, the user terminal 3 may instruct the scanner A to notify the user terminal 3 of the identification information of the scanner A.

In Step S502, the user terminal 3 waits for the confirmation operation to be performed. The second check unit 49 waits for the confirmation operation (operation of capturing an image of the right scanner (capturing the identification information of the right scanner)) of Step S503 to be performed by the user. The user is instructed to perform the confirmation operation in Step S107, and thus performs the confirmation operation (Step S503). When the confirmation operation is performed, the user terminal 3 (the identification information acquisition unit 48) performs a capturing process (Step S504). However, even when the confirmation operation is instructed, the confirmation operation (operation of Step S503) may not be performed for some reason. For this reason, the processing of Steps S503 and S504 is represented by a dotted line in FIG. 16. The order of Step S501 and Step S502 may be reversed. The process then proceeds to Step S505.

In Step S505, the user terminal 3 determines (checks) whether the confirmation operation has been performed. The second check unit 49 checks whether the confirmation operation has been performed by detecting whether the confirmation operation (operation of capturing an image of the right scanner (capturing the identification information of the right scanner) has been performed. When the second check unit 49 determines or confirms that the confirmation operation has been performed (Yes in Step S505), the process proceeds to Step S506. On the other hand, when the second check unit 49 fails to confirm that the confirmation operation is performed (No in Step S505), the process proceeds to Step S510.

In Step S506, the user terminal 3 performs a matching process. The second check unit 49 compares the identification information received in Step S501 with the identification information acquired by the processing of Step S504. As a result of the comparison, when the identification information matches, it can be determined that the apparatus intended by the user (right scanner) is successfully selected. On the other hand, when the identification information does not match, it can be determined that the apparatus intended by the user has not been successfully selected (has incorrectly selected). The process then proceeds to Step S507.

In Step S507, the user terminal 3 determines (checks) whether the identification information matches. The second check unit 49 checks whether the identification information received in Step S501 and the identification information acquired by the processing of Step S504 match, as a result of the matching processing of Step S506. When the two match (Yes in Step S507), the process proceeds to Step S508. On the other hand, when the two do not match (No in Step S507), the process proceeds to Step S511.

In Step S508, the user terminal 3 notifies the scanner A of the confirmation success. The second check unit 49 notifies (transmits) information indicating that the confirmation operation has succeeded (the identification information acquired by capturing the right scanner matches the identification information received from the scanner A that has completed the pairing, that is, the pairing has been established with the expected scanner) to the scanner A as the check result obtained by the second check unit 49. The process then proceeds to Step S509.

In Step S509, the user terminal 3 outputs a notification of the pairing completion. The processing of Step S509 is substantially the same as the processing of Step S205 in FIG. 10, and thus the description thereof is omitted. The order of Step S508 and Step S509 may be reversed. Then, the process illustrated in the flowchart ends.

In Step S510, the user terminal 3 determines whether the waiting time has elapsed. The second check unit 49 determines whether a predetermined time (waiting time) has elapsed from a time such as when the pairing is completed. When the waiting time has not elapsed (No in Step S510), the process returns to Step S502. On the other hand, when the waiting time has elapsed (Yes in Step S510), the process proceeds to Step S511.

In Step S511, the user terminal 3 notifies the scanner A of the confirmation failure. The second check unit 49 notifies (transmits) information indicating that the confirmation operation has failed (the identification information acquired by capturing the right scanner does not match the identification information received from the scanner A that has completed the pairing, that is, the pairing has not been established with the expected scanner) to the scanner A as the check result obtained by the second check unit 49. The process then proceeds to Steps S512 and S513.

In Steps S512 and S513, the pairing between the scanner A and the user terminal 3 is canceled. The order of Step S512 and Step S513 may be reversed. The processing of Step S512 and Step S513 is substantially the same as the processing of Step S208 and Step S209 in FIG. 11, and thus the description thereof is omitted. The process then proceeds to Step S514.

In Step S514, the user terminal 3 outputs a notification of the pairing failure. The processing of Step S514 is substantially the same as the processing of Step S210 in FIG. 11, and thus the description thereof is omitted. Then, the process illustrated in the flowchart ends.

As described above, according to the present embodiment, processing for pairing between the information processing device and the electronic apparatus can be enhanced by checking whether the confirmation operation (first predetermined operation) is performed related to the electronic apparatus (electronic apparatus that has paired with the information processing device) after the pairing is completed or whether the information input by the confirmation operation (second predetermined operation) performed after the pairing is completed meets the predetermined condition. Further, pairing between the electronic apparatus and the information processing device is performed using an authentication method (e.g., Just Works) that does not involve an operation for confirming that a connection destination is correct, resulting in facilitating the authentication procedure. That is, after pairing using an authentication method that does not involve an operation for confirming that a connection destination is correct is completed, it is confirmed whether a confirmation operation has been performed related to the electronic apparatus (the electronic apparatus that has been paired with the information processing device) or whether information input by the confirmation operation meets a predetermined condition (confirms that the connection destination is correct). That is, this can simplify the authentication procedure (facilitation of authentication) and prevent incorrect selection of the individual apparatus. Further, an authentication method (e.g., Just Works) that does not involve an operation for confirming that a connection destination is correct has no hardware restriction (requirement) on an apparatus (device) for which pairing is performed, and pairing can be performed by existing hardware.

Further, in the authentication method in pairing in the related art, hardware requirements such as the requirement of a liquid crystal display (LCD) and the requirement of an NFC-compatible device are imposed in some cases. In such a case, authentication fails to be performed by existing hardware, requiring additional hardware and thus increasing costs. However, according to the present embodiment, in each of the cases of the confirmation operations 1 to 4, the confirmation operation 6 (output of a specific light), and the confirmation operations 7 and 8, the check process using hardware included in a general electronic apparatus (scanner) is performed, and collation of authentication content by a screen or authentication by NFC is not performed. Accordingly, pairing can be performed by existing hardware without requiring additional hardware such as an LCD or NFC. This eliminates the cost of preparing additional hardware. For example, even a scanner without a screen (LCD) can implement a simple confirmation operation procedure. As described above, in the present embodiment, pairing is performed using a pairing method that does not perform authentication in accordance with a standard (that can be performed without a screen), a specific confirmation operation performable with existing hardware is performed by the user, and the information processing device or the electronic apparatus checks whether the confirmation operation has succeeded or failed to verify whether the individual apparatus (right scanner) intended by the user is selected.

In the cases of the confirmation operations 4 and 5, the confirmation operation can be easily performed by the user approaching the scanner 1 while carrying the user terminal 3 without performing a user operation on the scanner 1 or the user terminal 3. In the cases of the confirmation operations 6 and 7, the confirmation operation can be performed by performing a user operation on the user terminal 3 (a user operation does not have to be performed on the scanner 1), and thus the confirmation operation can be easily performed. In the case of the confirmation operation 8, since whether the identification information such as the serial number matches is determined, the accuracy of the confirmation procedure can be increased (connection with an unintended scanner can be prevented).

In the related art, a pairing process is performed when wireless communication is established according to wireless communication standards such as BLUETOOTH (registered trademark). However, there is potential for enhancement in this pairing process.

The present disclosure can be understood as an electronic apparatus, an information processing device, a system, a method executed by a computer, or a program executed by a computer. Further, the present disclosure can also be understood as a recording medium that stores such a program and that can be read by, for example, a computer or any other apparatus or machine. The recording medium that can be read by, for example, the computer refers to a recording medium that can store information such as data or programs by electrical, magnetic, optical, mechanical, or chemical action, and that can be read by, for example, a computer.

According to one or more embodiments of the present disclosure, a pairing process between an information processing device and an electronic apparatus can be enhanced

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disc (DVD), and/or the memory of an FPGA or ASIC.

1. An electronic apparatus, comprising circuitry configured to:
perform pairing with an information processing device in response to receiving a pairing request for wireless communication in accordance with a wireless communication standard from the information processing device to complete the pairing; and
check whether a first predetermined operation is performed related to the electronic apparatus after completion of the pairing or whether information input by a second predetermined operation performed after the completion of the pairing meets a predetermined condition.

2. The electronic apparatus of claim 1, wherein,
in a case where the circuitry checks whether the first predetermined operation is performed related to the electronic apparatus after the completion of the pairing, the circuitry is further configured to cancel the completed pairing when failing to confirm that the first predetermined operation is performed related to the electronic apparatus, within a predetermined period, and
in a case where the circuitry checks whether the information input by the second predetermined operation performed after the completion of the pairing meets the predetermined condition, the circuitry is further configured to cancel the completed pairing when failing to confirm that the information input by the second predetermined operation meets the predetermined condition, within the predetermined period.

3. The electronic apparatus of claim 1, wherein
the pairing between the electronic apparatus and the information processing device is performed using an authentication method that does not include an operation for confirming that a connection destination is correct.

4. The electronic apparatus of claim 3, wherein
in a case where the circuitry checks whether the first predetermined operation is performed related to the electronic apparatus after the completion of the pairing, the first predetermined operation is an operation to be performed related to a pairing target, and
in a case where the circuitry checks whether the information input by the second predetermined operation performed after the completion of the pairing meets the predetermined condition,
the second predetermined operation is an input operation of inputting a result obtained by checking whether a predetermined output indicating that pairing has been completed is performed by the pairing target, and the predetermined condition is that the information input by the input operation is the result indicating that the predetermined output is performed by the pairing target, or
the second predetermined operation is an imaging operation of imaging the pairing target, and the predetermined condition is that the information input by the imaging operation matches identification information identifying the electronic apparatus.

5. The electronic apparatus of claim 1, wherein
in a case where the circuitry checks whether the first predetermined operation is performed related to the electronic apparatus after the completion of the pairing, the first predetermined operation is an operation to be performed related to a pairing target, wherein
the first predetermined operation includes at least one of an operation of pressing a button of the pairing target, an operation of placing a medium on the pairing target, an operation for starting a specific function of the pairing target, an operation for restarting the pairing target, an operation of bringing the information processing device close to the pairing target, or an operation for establishing wireless communication in accordance with another wireless communication standard other than the wireless communication standard with the information processing device.

6. The electronic apparatus of claim 5, wherein
the circuitry is configured to check whether the first predetermined operation has been performed related to the electronic apparatus by detecting whether the first predetermined operation is performed related to the electronic apparatus or by receiving, from the information processing device, a result obtained by the information processing device detecting whether the first predetermined operation has been performed related to the electronic apparatus.

7. The electronic apparatus of claim 1, wherein
the circuitry is further configured to perform a predetermined output, wherein
in a case where the circuitry checks whether the information input by the second predetermined operation performed after the completion of the pairing meets the predetermined condition,
the second predetermined operation is an input operation of inputting a user confirmation result indicating whether the predetermined output performed by a pairing target has been confirmed, and
the circuitry checks whether the user confirmation result input by the input operation is a result indicating that the predetermined output performed by the pairing target has been confirmed.

8. The electronic apparatus of claim 7, wherein
the circuitry is configured to receive the user confirmation result from the information processing device or receive a user operation of inputting the user confirmation result.

9. The electronic apparatus of claim 7, wherein
the predetermined output is at least one of output of a specific light, display of a specific screen, output of a specific sound, or generation of a specific vibration.

10. The electronic apparatus of claim 1, wherein
in a case where the circuitry checks whether the information input by the second predetermined operation performed after the completion of the pairing meets the predetermined condition,
the second predetermined operation is an imaging operation of imaging a pairing target, and
the circuitry is configured to check whether the information input by the imaging operation matches identification information identifying the electronic apparatus.

11. The electronic apparatus of claim 10, wherein
the circuitry is further configured to receive a result obtained by the information processing device checking whether the information input by the imaging operation matches the identification information transmitted from the electronic apparatus to the information processing device or receive the information input by the input operation from the information processing device, to check whether the information input by the imaging operation matches the identification information identifying the electronic apparatus.

12. The electronic apparatus of claim 2, wherein
each of the first predetermined operation and the second predetermined operation is instructed to be performed after the completion of the pairing, and
the predetermined period is dynamically changeable by at least one of the electronic apparatus or the information processing device according to at least one of details of the first predetermined operation or the second predetermined operation, a user characteristic, or settings of the electronic apparatus or the information processing device.

13. The electronic apparatus of claim 1, wherein
each of the first predetermined operation and the second predetermined operation is instructed to be performed after the completion of the pairing, and
details of the first predetermined operation or the second predetermined operation are dynamically changeable by at least one of the electronic apparatus or the information processing device according to at least one of a user characteristic, settings of the electronic apparatus, a function of the electronic apparatus, settings of the information processing device, or a function of the information processing device.

14. The electronic apparatus of claim 1, wherein
the circuitry is further configured to omit a check process of checking whether the first predetermined operation is performed related to the electronic apparatus after the completion of the pairing or whether the information input by the second predetermined operation performed after the completion of the pairing meets the predetermined condition, when determining that a predetermined omission condition is met before performing the check process.

15. The electronic apparatus of claim 14, wherein
the predetermined omission condition is a condition related to a positional relationship between the information processing device and the electronic apparatus or a condition related to a type of the information processing device.

16. An electronic apparatus, comprising circuitry configured to:
receive a pairing request;
establish a pairing based on the pairing request;
determine to cancel the pairing when failing to confirm that a first predetermined operation is performed related to the electronic apparatus or when failing to confirm that information input by a second predetermined operation meets a predetermined condition, within a predetermined time after the pairing is established.

17. An information processing device, comprising circuitry configured to:
transmit a pairing request to an electronic apparatus; and
check whether a first predetermined operation is performed related to the electronic apparatus after pairing for wireless communication in accordance with a wireless communication standard is completed based on the pairing request or whether information input by a second predetermined operation performed after completion of the pairing meets a predetermined condition.

18. The information processing device of claim 17, wherein,
in a case where the circuitry checks whether the first predetermined operation is performed related to the electronic apparatus after the pairing for wireless communication in accordance with the wireless communication standard is completed based on the pairing request, the circuitry is further configured to display a message when the circuitry fails to confirm that the first predetermined operation is performed related to the electronic apparatus and when the pairing previously performed is canceled, wherein the message indicates that pairing with the electronic apparatus is to be performed in accordance with the wireless communication standard based on the pairing request and that one of the first predetermined operation and the second predetermined operation is to be performed after the pairing with the electronic apparatus is completed, and
in a case where the circuitry checks whether the information input by the second predetermined operation performed after the completion of the pairing meets the predetermined condition, the circuitry is further configured to display the message when the circuitry fails to confirm that the information input by the second predetermined operation meets the predetermined condition and when the pairing previously performed is canceled.
